(19) United States
(12) Patent Application Publication
(10) Pub. No.: US 2006/0280358 A1
(43) Pub. Date: Dec. 14, 2006

(54) Pattern comparison inspection method and pattern comparison inspection device

(76) Inventor: Akio Ishikawa, Tokyo (JP)

Correspondence Address: CHRISTIE, PARKER & HALE, LLP, PO BOX 7068, PASADENA, CA, 91109-7068, US

(21) Appl. No.: 10/562,751

(22) PCT Filed: Jun. 29, 2004
(86) PCT No.: PCT/JP04/09503

§ 371 Date: Dec. 28, 2005

(30) Foreign Application Priority Data
Jun. 30, 2003 (JP) 2003-187479

(51) Int. Cl. G06K 9/00

(52) U.S. Cl. 382/149

(57) ABSTRACT

A pattern comparison inspection apparatus comprises: a reference position selecting portion (41) which selects from among positions on an inspection target pattern a reference position which is judged whether it should be contained in an inspection region; an image comparing portion (42) which compares an image signal at the reference position with an image signal at a position located an integral multiple of a repeat pitch away from the reference position; and an inspection region setting portion (43) which sets the inspection region by containing therein the reference position when a comparison result from the image comparing portion shows a value not greater than a prescribed threshold value. Thus, in the pattern comparison inspection apparatus which performs inspection for a pattern defect by comparing repeated patterns with each other in the inspection target pattern having a repeated pattern region, the inspection region can be enlarged within the bounds of the repeated pattern region.

### TECHNICAL FIELD

The present invention relates to a pattern comparison inspection method and apparatus which performs inspection for a defect, etc. by comparing repeated patterns, with each other, in a pattern having repeated patterns repeated with a prescribed period (pitch) and, more particularly, to an appearance inspection method and apparatus whereby a pattern such as a photomask pattern or a pattern formed on a semiconductor wafer of a semiconductor memory or the like, having repeated cell patterns, is inspected by sequentially comparing one cell pattern with another cell pattern in the neighborhood of the one cell pattern.

### BACKGROUND ART

It is widely practiced to generate image data by capturing an image of a formed pattern and to inspect the pattern for a defect, etc. by analyzing the image data. In particular, in the field of semiconductor fabrication, photomask inspection equipment for inspecting photomasks and appearance inspection equipment for inspecting patterns formed on semiconductor wafers are widely used. The present invention is applicable to inspecting any kind of pattern as long as the pattern is one, such as a photomask pattern or a pattern formed on a wafer, that is formed by repeating a basic pattern, but the following description is given by taking, as an example, the image data obtained by optically capturing an image of a pattern formed on a wafer.

FIG. 27 shows an arrangement of semiconductor chips 201 constructed on a semiconductor wafer 200. As each such semiconductor chip 201 is called a die, the term “die” is also used in this specification. In the fabrication process of semiconductor devices, since many layers of patterns are formed on the wafer 200, not only does it take a long time to complete all the fabrication steps but, if there is a critical defect even in one layer, the affected die is rendered defective, which decreases the fabrication yield. Therefore, it is practiced to capture an image of formed patterns halfway through the process and analyze the image data to check for defects; if there is a layer containing a critical defect, the layer is removed and formed once again, or defect information is fed back to the fabrication process, to improve the fabrication yield. An appearance inspection apparatus (inspection machine) is used for this purpose.

FIG. 28 is a diagram schematically showing the configuration of a prior art appearance inspection apparatus. As shown in FIG. 28, the wafer 200 is held on a stage 211. Light emitted from a light source 214 is converged by a condenser lens 215 and reflected by a half-silvered mirror 213 into an objective lens 212 through which the light is focused to illuminate the surface of the wafer 200. An optical image on the illuminated surface of the wafer 200 is projected via the objective lens 212 onto an imaging device 216 (refer, for example, to Japanese Unexamined Patent Publication No. 2002-342757).

The imaging device 216 converts the optical image into an image signal which is an electrical signal. The image signal is then converted into image data in digital form, and stored in an image memory 217. An image processor 218 processes the image data stored in the image memory 217 and checks for the presence or absence of a defect, etc. A controller 219 controls the various parts of the apparatus, such as the stage 211, the image memory 217, and the image processor 218.

Patterns formed on semiconductor devices are very fine, and an extremely high resolving power is required of the appearance inspection apparatus. In view of this, a one-dimensional image sensor is used as the imaging device, and the stage 211 is moved (scanned) in a single direction, in synchronism with which the output of the imaging device is sampled to obtain the image data.

When the width H on the wafer that can be captured by the sensor at one time is smaller than the width of each die 201, the corresponding portions on the respective dice are scanned in sequence as, for example, shown in FIG. 27, and when the scanning is completed for all the dice, the next corresponding portions on the respective dice are scanned in sequence, and so on to obtain the image data for all the portions of each die. This serves to improve throughput because the image data can be obtained by performing the scanning while, at the same time, making comparisons between the corresponding portions of the dice obtained from the previous scanning. The method of scanning is not limited to the above-described one and various other methods have been proposed.

FIG. 29 is a diagram for explaining how the image data are compared between adjacent dice. It is assumed that dice A, B, C, and D are arranged as shown in FIG. 29. The image data are defined with each pixel 210 treated as a unit.

As shown, when comparing the image data between the dice B and C, the image data (pixel data) of the corresponding pixels on the dice B and C are compared with each other. For example, the pixel data in the first column in row “a” on the die B is compared with the corresponding pixel data on the die C.

The comparison of the image data between the dice is usually done by generating and storing the image data in sequence starting from the die at one end and, by comparing the newly generated image data of each die with the previously generated and stored image data of the preceding die, that is, first between A and B, then between B and C, and then between C and D. In this way, each of the dice located between the dice at both ends is compared twice, first with one adjacent die and then with the other adjacent die; if the result of the comparison does not show a match in any of the two comparisons, then the condition is determined as being a fault (a defect is detected). Such a comparison between dice is called a die-to-die comparison.

Semiconductor memories, etc. are formed from repeated patterns of a basic unit called a cell, and the pattern is formed by repeating the basic pattern corresponding to the cell. FIG. 30 is a diagram for explaining such cells; as shown, the cells 231 are arranged in a repeated fashion within the die 201. When inspecting the pattern in which such cells are arranged at a prescribed pitch, the presence or absence of a defect is checked, not by the die-to-die comparison described above, but by comparing the corresponding image data between adjacent cells. Such a comparison is called a cell-to-cell comparison.

In the cell-to-cell comparison, like the die-to-die comparison described above, the comparison is usually done by generating and storing the image data in sequence starting from the cell at one edge, and by comparing the newly generated image data of each cell with the previously generated and stored image data of its adjacent cell.

### DISCLOSURE OF INVENTION

In cell-to-cell comparison, if image data of a pattern outside a repeated pattern region 232 is contained in the image data of one of the two cells to be compared, the patterns of the two cells do not match, resulting in false detection of a defect; therefore, care must be taken to ensure that none of the image data to be compared in the cell-to-cell comparison contains a pattern outside the repeated pattern region 232.

In the prior art inspection apparatus, an inspection region (care area) 233 has been set by providing a margin to each edge of the repeated pattern region 232, for reasons such as the mechanical accuracy of the stage 211, etc. on which the wafer 200 is held. Then, the cell-to-cell comparison has been performed only on the patterns inside the inspection region 233, and the repeated patterns outside the inspection region 233 have been inspected by using the die-to-die comparison technique.

However, the patterns are formed at high density in the repeated pattern region 232, while the peripheral circuit patterns outside the repeated pattern region 232 are formed at low density; as a result, the patterns inside the repeated pattern region 232 are detected as dark areas, while the peripheral circuit patterns are detected as light areas.

Accordingly, in the case of the die-to-die comparison in which both the repeated patterns outside the inspection region 233 and the peripheral circuit patterns are contained, as the image of the repeated pattern region 232 is detected much darker than the image of the peripheral circuit patterns, there has been the problem that the defect detection sensitivity drops for the repeated patterns outside the inspection region 233.

In view of the above situation, in a pattern comparison inspection method and apparatus which performs inspection for a pattern defect by comparing repeated patterns with each other in an inspection target pattern having a repeated pattern region, it is an object of the present invention to enlarge the inspection region, where the repeated patterns are compared with each other, as far as possible within the bounds of the repeated pattern region.

To achieve the above object, in a pattern comparison inspection method according to a first mode of the present invention, a reference position, which is judged whether it should be contained in the inspection region is selected, an image signal at the reference position is compared with an image signal at a position located an integral multiple of a repeat pitch away from the reference position, and when the result of the comparison shows a value not greater than a prescribed threshold value, the inspection region is set so as to contain therein the reference position.

The pattern comparison inspection method according to the present invention will be described below with reference to FIGS. 1 and 2. FIG. 1 is a diagram for explaining the basic principle of the pattern comparison inspection method according to the present invention, and FIG. 2 is a flowchart of the pattern comparison inspection method according to the first mode of the present invention.

As shown in FIG. 1, repeated patterns 2 are formed as cells in a repeated fashion at a prescribed repeat pitch within a repeated pattern region 3 on a die 1. In step S101, image data is acquired from a region ABA′B′ on the die 1 by scanning the region with an imaging means such as a one-dimensional image sensor.

In step S103, the reference position, which is judged whether it should be contained in the inspection region, is selected from among positions within the image data of the region ABA′B′. Here, the reference position is set at two positions respectively located x₁ and x₂ away from the edge of the die 1.

In step S105, the image signal (pixel block) at the reference position is compared with an image signal at a position located inwardly of the reference position and spaced apart from it by an integral multiple of the repeat pitch of the repeated patterns. Here, the pixel block 4 located at the distance x₁ from the edge of the die 1 is compared with the pixel block 4′ located away from the pixel block 4 by a distance equal to the repeat pitch and, likewise, the pixel block 5 located at the distance x₂ from the edge of the die 1 is compared with the pixel block 5′ located away from the pixel block 5 by a distance equal to the repeat pitch.

In the pixel block comparison, the grayscale values of the corresponding pixels in the respective pixel blocks are compared with each other, and a count of the number of pixels found to have a grayscale value difference greater than a predetermined inter-pixel comparison threshold value may be taken as the result of the comparison. It will also be noted that the integer that defines the spacing between the reference position and the position spaced away from it by an integral multiple of the repeat pitch need not necessarily be the same as the integer that defines the cell spacing in the cell-to-cell comparison.

When the pixel block 5 located at the distance x₂ from the edge of the die 1 is compared with its corresponding pixel block 5′, the value of the comparison result is small because both pixel blocks are constructed from image data obtained by capturing the same portion of the repeated pattern; on the other hand, when the pixel block 4 located at the distance x₁ from the edge of the die 1 is compared with its corresponding pixel block 4′, the value of the comparison result is large because these blocks are constructed from image data obtained by capturing respectively different patterns.

Accordingly, in steps S107 and S109, while incrementally shifting the reference position in one prescribed direction outwardly (or inwardly) toward the boundary of the repeated pattern region 3, a search is made to detect a position xₚ at which the value of the comparison result becomes larger (or smaller) than the number of pixels defined by the predetermined threshold value tₕ. In this way, the region bounded by the reference position at which the value of the comparison result becomes larger (or smaller) than the predetermined threshold value tₕ is obtained, and this region is set as the inspection region in step S111.

By obtaining the region bounded by the reference position at which the value of the comparison result becomes smaller than the predetermined threshold value tₕ, and by setting this region as the inspection region, as described above, the inspection region can be enlarged as far as possible within the bounds of the repeated pattern region 3.

As shown in FIG. 1, when the reference position is incrementally shifted in one prescribed direction outwardly (or inwardly) toward the boundary of the pattern region 3, the value of the comparison result abruptly changes (increases) when the reference position reaches the position xₚ at the boundary of the repeated pattern region 3.

In view of this, in a pattern comparison inspection method according to a second mode of the present invention, the reference position, which is judged whether it should be contained in the inspection region, is selected while incrementally shifting the reference position by a prescribed distance within the inspection target pattern, the image signal at the reference position is compared with an image signal at a position located an integral multiple of the repeat pitch away from the reference position, and the reference position is set as the boundary of the inspection region when the result of the comparison shows a change greater than a prescribed threshold value.

FIG. 3 is a flowchart according to the second mode of the present invention.

In step S114, the contents of a storing portion for storing the previous comparison result are initialized. This storing portion is used to compare the previous comparison result with the present comparison result and compute the amount of change or rate of change between the comparison results.

Then, as in the pattern comparison inspection method according to the first mode described above, the image data of the region ABA′B′ on the die 1 is acquired in step S101, the reference position is selected in step S103 from among positions within the image data of the region ABA′B′, and the image signal (pixel block) at the reference position is compared in step S105 with an image signal at a position located inwardly of the reference position and spaced apart from it by an integral multiple of the repeat pitch of the repeated patterns.

In step S107, the amount of change or rate of change between the comparison result stored in the storing portion and the comparison result obtained in step S105 is computed, and it is determined whether the amount of change or rate of change between the comparison results is not greater than a predetermined threshold value tᵥ. If the amount or rate of change between the comparison results is not greater than the predetermined threshold value tᵥ, then in step S115 the comparison result obtained in step S105 is stored in the storing portion for computation of the amount or rate of change for the next time, and in step S109, the reference position is shifted in one prescribed direction outwardly (or inwardly) toward the boundary of the repeated pattern region 3. After that, the process returns to step S105, to repeat the steps S105, S107, S115 and S109.

If the result of the determination in step S107 shows that the rate of change between the comparison results is greater than the predetermined threshold value tᵥ, then in step S111 the inspection region is determined by setting the present reference position as the boundary of the inspection region.

Here, in step S107, instead of determining whether the amount or rate of change of the comparison result is not greater than the predetermined threshold value tᵥ, it may be determined whether or not the amount or rate of change of the comparison result becomes a maximum and, if the amount or rate of change of the comparison result is a maximum, the present reference position may be set as the boundary of the inspection region in step S111. For this purpose, the storing portion may be configured to store the largest value among the amounts or rates of change of the comparison results computed in the past loops, in addition to the comparison result obtained in the previous loop (S105, S107, S115, and S109). Then, in step S115, when storing the comparison result obtained in S105, it may be determined whether the amount or rate of change of the comparison result, computed in step S107, exceeds the largest value of the amount or rate of change of the comparison result stored in the storing portion and, if it exceeds the largest value, then the largest value of the amount or rate of change of the comparison result, stored in the storing portion, may be updated accordingly.

A pattern comparison inspection method according to a third mode of the present invention, which captures an image of an inspection target pattern having a repeated pattern region with repeated patterns formed in a repeated fashion at a prescribed repeat pitch, and which detects a defect in the inspection target pattern by comparing image signals taken from positions located an integral multiple of the repeat pitch away from each other, comprises: a defect candidate detecting step for comparing a predetermined first threshold value with a difference value between pixels separated from each other by a number of pixels equivalent to the integral multiple of the repeat pitch in the captured image of the inspection target pattern, and for detecting any pixel for which the difference value exceeds the first threshold value as a defect candidate; an inspection range determining step for selecting a reference range of a prescribed size within the captured image of the inspection target pattern, and for determining an inspection range by containing therein the reference range if the number of defect candidates contained in the reference range or the proportion of the defect candidates contained in the reference range is smaller than a predetermined second threshold value; and a detecting step for detecting a defect in the inspection target pattern within the inspection range.

The pattern comparison inspection method according to the third mode of the present invention may further comprise: a defect candidate map generating step for generating a defect candidate map by obtaining a defect candidate in the defect candidate detecting step for each pixel in the captured image of the inspection target pattern; and a reference range selecting step for selecting a reference range of a prescribed size within the defect candidate map, wherein the inspection range determining step determines the inspection range by containing therein the selected reference range if the number of defect candidates contained in the reference range or the proportion of the defect candidates contained in the reference range is smaller than the predetermined second threshold value.

A pattern comparison inspection method according to a fourth mode of the present invention, which captures an image of an inspection target pattern having a repeated pattern region with repeated patterns formed in a repeated fashion at a prescribed repeat pitch, and which detects a defect in the inspection target pattern by comparing image signals taken from positions located an integral multiple of the repeat pitch away from each other, comprises: a defect candidate detecting step for comparing a predetermined first threshold value with a difference value taken between pixels separated from each other by a number of pixels equivalent to the integral multiple of the repeat pitch in the captured image of the inspection target pattern, and for detecting any pixel for which the difference value exceeds the first threshold value as a defect candidate; an inspection range determining step for selecting a reference range of a prescribed size within the captured image of the inspection target pattern by incrementally changing the position of the reference range relative to a prescribed direction, and for determining an inspection range by containing therein the position relative to the prescribed direction if the number of defect candidates contained in the reference range or the proportion of the defect candidates contained in the reference range is smaller than a predetermined second threshold value; and a detecting step for detecting a defect in the inspection target pattern within the inspection range.

The pattern comparison inspection method according to the fourth mode of the present invention may further comprise: a defect candidate map generating step for generating a defect candidate map by obtaining a defect candidate in the defect candidate detecting step for each is pixel in the captured image of the inspection target pattern; and a reference range selecting step for selecting a reference range of a prescribed size within the defect candidate map, wherein the inspection range determining step determines the inspection range by containing therein the selected reference range if the number of defect candidates contained in the reference range or the proportion of the defect candidates contained in the reference range is smaller than the predetermined second threshold value.

A pattern comparison inspection apparatus according to a fifth mode of the present invention comprises: a reference position selecting portion which selects from among positions on the inspection target pattern the reference position which is judged whether it should be contained in the inspection region; an image comparing portion which compares an image signal at the reference position with an image signal at a position located an integral multiple of the repeat pitch away from the reference position; and an inspection region setting portion which sets the inspection region by containing therein the reference position when the result of the comparison from the image comparing portion shows a value not greater than a prescribed threshold value.

Further, a pattern comparison inspection apparatus according to a sixth mode of the present invention comprises: a reference position selecting portion which selects the reference position which is judged whether it should be contained in the inspection region, by incrementally shifting the reference position by a prescribed distance within the inspection target pattern; an image comparing portion which compares an image signal at the reference position with an image signal at a position located an integral multiple of the repeat pitch away from the reference position; and an inspection region setting portion which sets the reference position as the boundary of the inspection region when the result of the comparison obtained from the image comparing portion as a result of incrementally shifting the reference position by the prescribed distance shows a change greater than a prescribed threshold value.

A pattern comparison inspection apparatus according to a seventh mode comprises: an imaging portion which captures an image of an inspection target pattern having a repeated pattern region with repeated patterns formed in a repeated fashion at a prescribed repeat pitch; a pattern comparing portion which compares, on the captured image, image signals taken from positions located an integral multiple of the repeat pitch away from each other; a defect detecting portion which detects a defect in the inspection target pattern based on the result of the comparison; a defect candidate detecting portion which compares a predetermined first threshold value with a difference value taken between pixels separated from each other by a number of pixels equivalent to the integral multiple of the repeat pitch in the captured image of the inspection target pattern, and which detects any pixel for which the difference value exceeds the first threshold value as a defect candidate; and an inspection range determining portion which selects a reference range of a prescribed size within the captured image of the inspection target pattern, and which determines an inspection range by containing therein the reference range if the number of defect candidates contained in the reference range or the proportion of the defect candidates contained in the reference range is smaller than a predetermined second threshold value, wherein the defect detecting portion detects a defect in the inspection target pattern within the inspection range.

The pattern comparison inspection apparatus according to the seventh mode of the present invention may further comprise: a defect candidate map generating portion which generates a defect candidate map by obtaining a defect candidate from the defect candidate detecting portion for each pixel in the captured image of the inspection target pattern; and a reference range selecting portion which selects a reference range of a prescribed size within the defect candidate map. In this case, the inspection range determining portion may determine the inspection range by containing therein the selected reference range if the number of defect candidates contained in the reference range or the proportion of the defect candidates contained in the reference range is smaller than the predetermined second threshold value.

A pattern comparison inspection apparatus according to an eighth mode comprises: an imaging portion which captures an image of an inspection target pattern having a repeated pattern region with repeated patterns formed in a repeated fashion at a prescribed repeat pitch; a pattern comparing portion which compares, on the captured image, image signals taken from positions located an integral multiple of the repeat pitch away from each other; a defect detecting portion which detects a defect in the inspection target pattern based on the result of the comparison; a defect candidate detecting portion which compares a predetermined first threshold value with a difference value taken between pixels separated from each other by a number of pixels equivalent to the integral multiple of the repeat pitch in the captured image of the inspection target pattern, and which detects any pixel for which the difference value exceeds the first threshold value as a defect candidate; and an inspection range determining portion which selects a reference range of a prescribed size within the captured image of the inspection target pattern by incrementally changing the position of the reference range relative to a prescribed direction, and which determines an inspection range by containing therein the position relative to the prescribed direction if the number of defect candidates contained in the reference range or the proportion of the defect candidates contained in the reference range is smaller than a predetermined second threshold value, wherein the defect detecting portion detects a defect in the inspection target pattern within the inspection range.

The pattern comparison inspection apparatus according to the eighth mode of the present invention may further comprise: a defect candidate map generating portion which generates a defect candidate map by obtaining a defect candidate from the defect candidate detecting portion for each pixel in the captured image of the inspection target pattern; and a reference range selecting portion which selects a reference range of a prescribed size within the defect candidate map by incrementally changing the position of the reference range relative to a prescribed direction, wherein the inspection range determining portion determines the inspection range by containing therein the position relative to the prescribed direction if the number of defect candidates contained in the reference range or the proportion of the defect candidates contained in the reference range is smaller than the predetermined second threshold value.

In the pattern comparison inspection method and apparatus according to the present invention described in this specification, the cell region formed within a die is selected as the repeated pattern region, and the inspection range is set for the pattern comparison inspection of the cell region within the die, but alternatively, the pattern comparison inspection method and apparatus according to the present invention may be used to select the die region formed on a wafer as the repeated pattern region and to set the inspection range for the pattern comparison inspection of the die region.

According to the present invention, the inspection region where repeated patterns are compared with each other can be enlarged as far as possible in a pattern comparison inspection, which checks for the presence or absence of a pattern defect, by comparing the repeated patterns with each other within the inspection target pattern.

Further, as in the pattern comparison inspection methods according to the third and fourth modes and the pattern comparison inspection apparatuses according to the seventh and eighth modes of the present invention, if the inspection range is determined by using the defect candidates detected for the defect inspection, the amount of computation required to compare the pixel values of the captured image to determine the inspection range can be reduced, which contributes to enhancing the inspection speed.

### BRIEF DESCRIPTION OF THE DRAWINGS

FIG. 1 is a diagram for explaining the basic principle of a pattern comparison inspection method according to the present invention.

FIG. 2 is a flowchart of a pattern comparison inspection method according to a first mode of the present invention.

FIG. 3 is a flowchart of a pattern comparison inspection method according to a second mode of the present invention.

FIG. 4 is a diagram schematically showing the configuration of a pattern comparison inspection apparatus according to an embodiment of the present invention.

FIG. 5 is a flowchart (part 1) of a pattern comparison inspection method according to a first embodiment of the present invention.

FIG. 6 is a flowchart (part 2) of the pattern comparison inspection method according to the first embodiment of the present invention.

FIG. 7 is a diagram for explaining how a tentative region is set on an inspection pattern having a repeated pattern region.

FIG. 8 is a diagram for explaining a method for capturing an image of the inspection pattern having the repeated pattern region.

FIG. 9A and FIG. 9B are diagrams each showing an image signal of the captured inspection pattern. FIG. 9C is a graph showing how the value of a comparison result varies as a reference position is moved.

FIG. 10A and FIG. 10B are diagrams each showing the condition in which a defect image is contained in the image signal of the captured inspection pattern.

FIG. 11 is a flowchart (part 3) of the pattern comparison inspection method according to the first embodiment of the present invention.

FIG. 12 is a flowchart (part 4) of the pattern comparison inspection method according to the first embodiment of the present invention.

FIG. 13A and FIG. 13B are diagrams each showing an image signal of the captured inspection pattern. FIG. 13C is a graph showing how the value of the comparison result varies as the reference position is moved. FIG. 13D is diagram showing an image signal of the captured inspection pattern.

FIG. 14 is a diagram for explaining a technique for storing captured images of the inspection pattern.

FIG. 15 is a flowchart (part 1) of a pattern comparison inspection method according to a second embodiment of the present invention.

FIG. 16 is a flowchart (part 2) of the pattern comparison inspection method according to the second embodiment of the present invention.

FIG. 17 is a diagram for explaining how the tentative region is set on the inspection pattern according to the second embodiment.

FIG. 18A and FIG. 18B are diagrams each showing an image signal of the captured inspection pattern. FIG. 18C is a graph showing how the value of the comparison result varies as the reference position is moved.

FIG. 19A is diagram showing a repeated pattern region having a defect. FIG. 19B is a graph showing how the value of the comparison result varies.

FIG. 20 is a diagram schematically showing the configuration of a pattern comparison inspection apparatus according to a third embodiment of the present invention.

FIG. 21 is a flowchart of a pattern comparison inspection method according to the third embodiment of the present invention.

FIG. 22A is a diagram showing an image signal of a captured inspection pattern.

FIG. 22B is a diagram showing an image signal obtained by delaying the image signal shown in FIG. 22A.

FIG. 22C is a diagram showing a defect map image signal generated based on the difference between FIGS. 22A and 22B.

FIG. 22D is a diagram showing the defect map image signal in its entirety.

FIG. 23A is a diagram showing the defect map image signal.

FIG. 23B is a graph showing the variation, along an X direction, of the number of defect candidates contained in a reference range.

FIG. 24 is a diagram schematically showing the configuration of a pattern comparison inspection apparatus according to a fourth embodiment of the present invention.

FIG. 25 is a flowchart of a pattern comparison inspection method according to the fourth embodiment of the present invention.

FIG. 26 is a diagram for explaining the pattern comparison inspection method according to the fourth embodiment of the present invention.

FIG. 27 is a diagram showing an arrangement of semiconductor chips (dice) constructed on a semiconductor wafer and a scanning path for testing.

FIG. 28 is a diagram schematically showing the configuration of an appearance inspection apparatus for inspecting the dice formed on the semiconductor wafer.

FIG. 29 is a diagram for explaining a die-to-die comparison.

FIG. 30 is a diagram for explaining cells, a repeated pattern region, and an inspection region within a die.

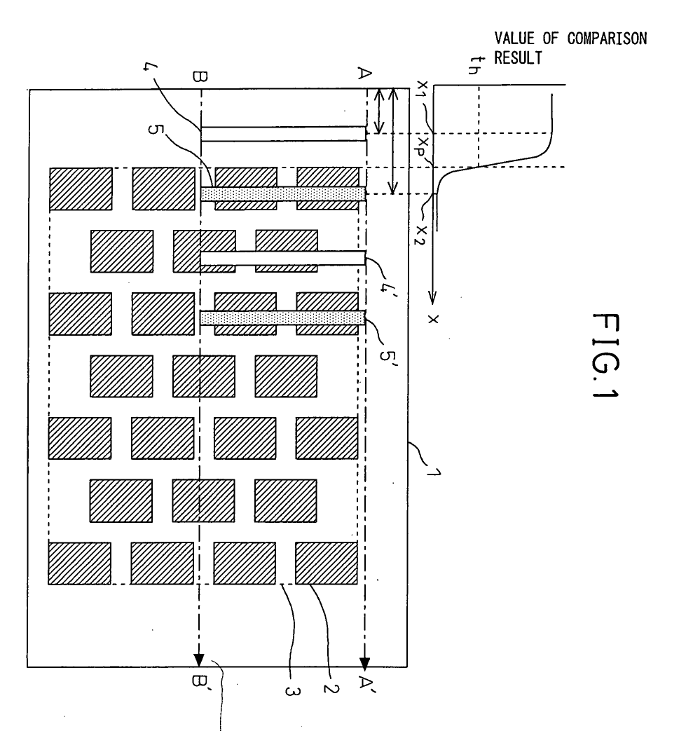

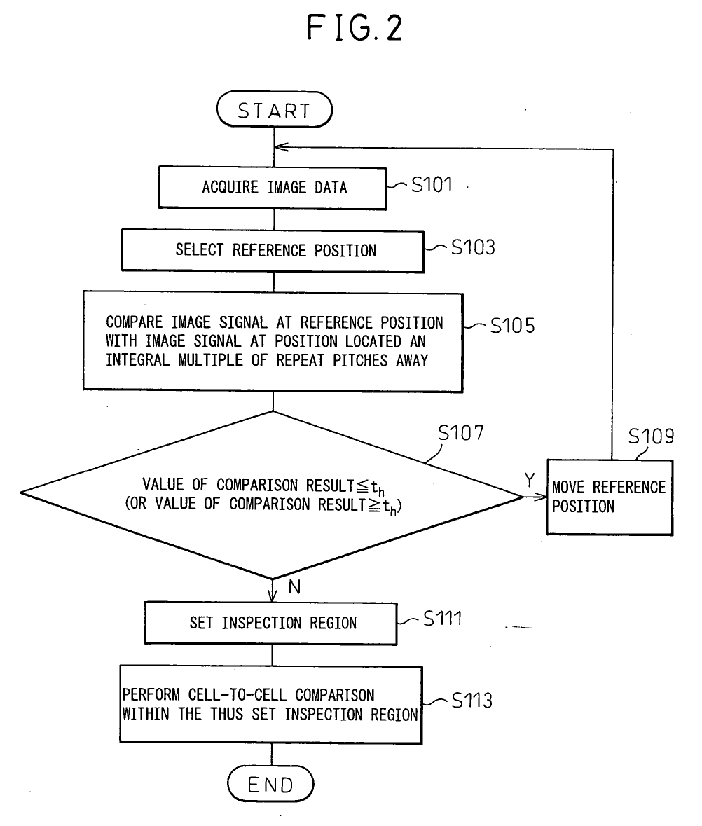

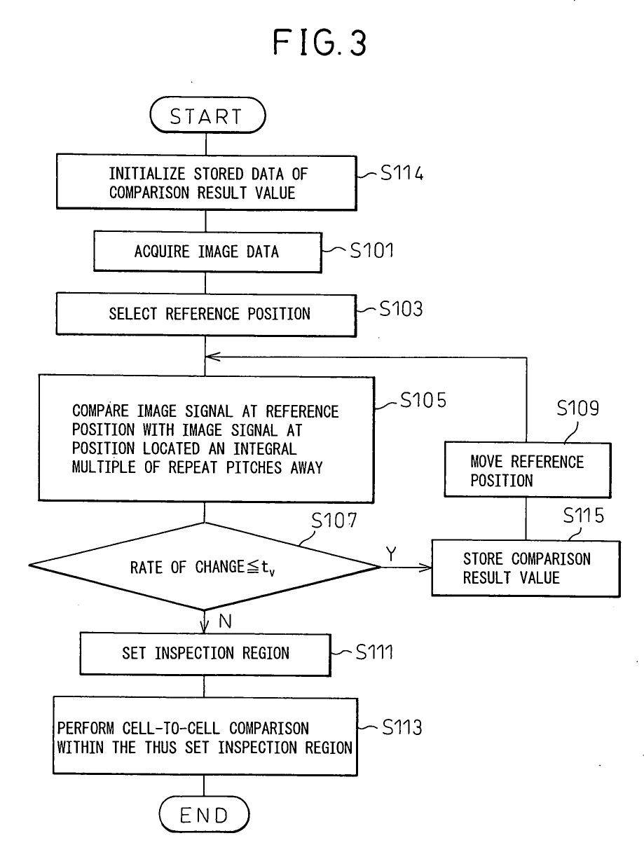

### BEST MODE FOR CARRYING OUT THE INVENTION

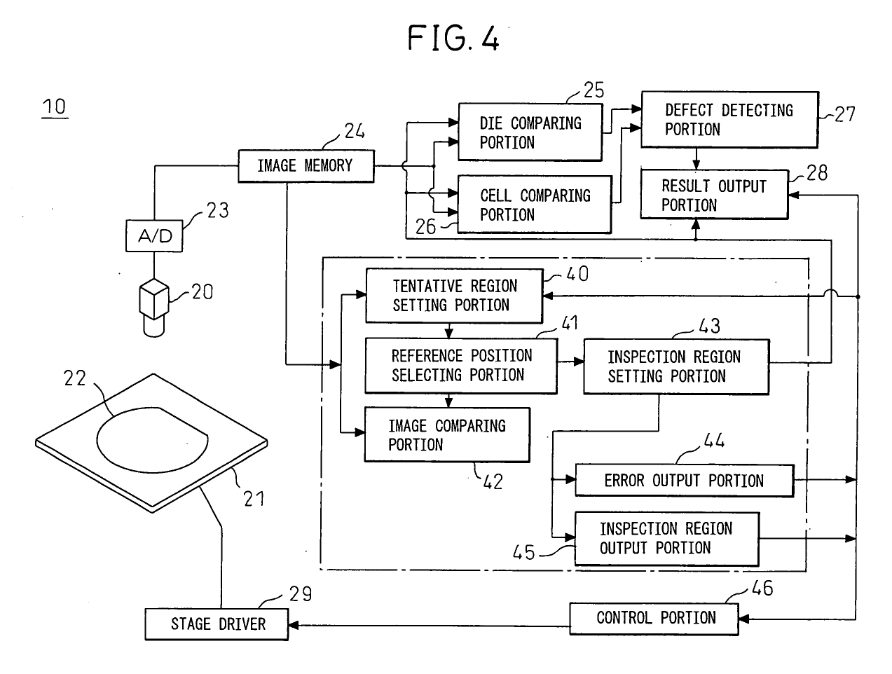

Embodiments of the present invention will be described below with reference to the accompanying drawings. FIG. 4 is a diagram schematically showing the configuration of a pattern comparison inspection apparatus according to a first embodiment of the present invention.

The pattern comparison inspection apparatus 10 comprises: a stage 21 for holding thereon a wafer 22 on which circuit patterns or the like containing repeated patterns of memory cells, etc. are formed; an imaging portion 20, such as a one-dimensional image sensor, for capturing an image of the patterns formed on the wafer 22; and a stage controller 29 for moving the stage 21 so that the wafer 22 is scanned by the imaging portion 20 in order for the imaging portion 20 to capture the image of the patterns across the entire surface of the wafer 22.

The pattern comparison inspection apparatus 10 further comprises: an A/D converter 23 which converts the captured analog image signal into an image signal in digital form; an image memory 24 which stores the thus converted image signal pattern in digital form; a die comparing portion 25 which, based on the stored image signal pattern, performs a die-to-die comparison on the patterns formed on the wafer 22; a cell comparing portion 26 which performs a cell-to-cell comparison; a defect detecting section 27 which detects a defect in the formed pattern based on the result of the comparison; and a result output portion 28 which outputs the detected result.

The pattern comparison inspection apparatus 10 further comprises setting portion which sets, within the captured pattern image, an inspection region in which the cell comparing portion 26 performs the cell-to-cell comparison, the setting portion including a tentative region setting portion 40, a reference position selecting portion 41, an image comparing portion 42, and an inspection region setting portion 43 shown in FIG. 4. Position data indicating the position of each pattern formed on the wafer 22 is supplied to a control portion 46 which, based on the position data, computes the position of the repeated pattern region 3 on the wafer 22 and supplies it to the tentative region setting portion 40.

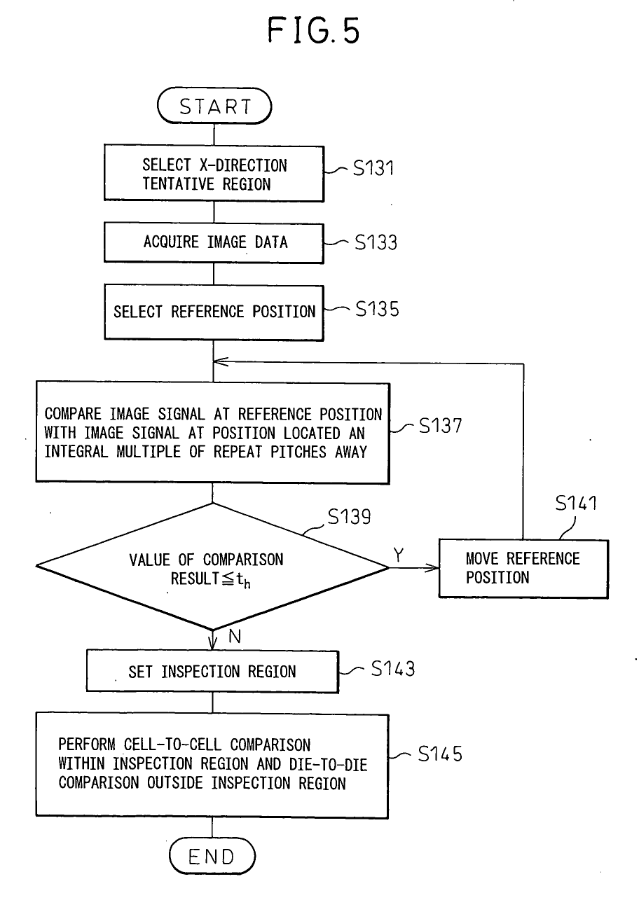

The operation of the pattern comparison inspection apparatus 10 will be described below with reference to FIGS. 5 to 15.

FIG. 5 is a flowchart of a pattern comparison inspection method according to the first embodiment of the present invention, for explaining the operation of the pattern comparison inspection apparatus 10.

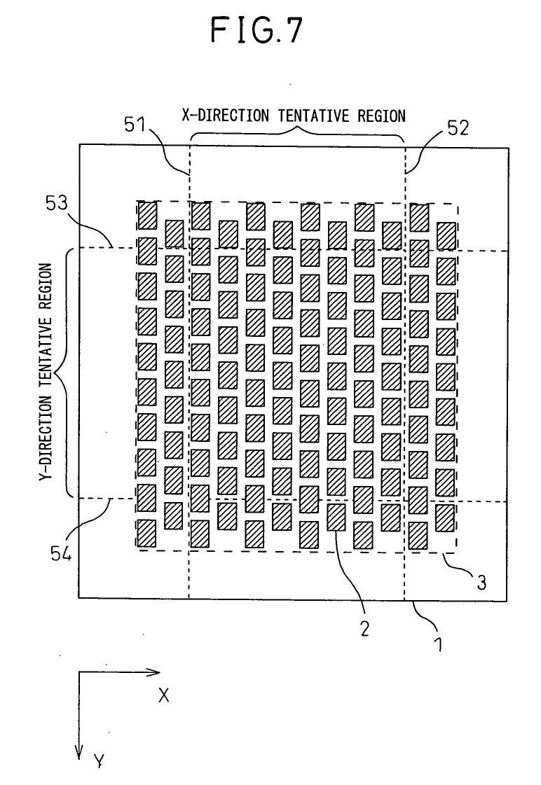

In step S131, an X-direction tentative region bounded by boundary lines 51 and 52 is set in relationship to the repeated pattern region 3 in which repeated patterns 2 are formed in a repeated fashion, as shown in FIG. 7, on the die 1 fabricated on the wafer 22. Here, the X and Y directions are defined as shown in FIG. 7.

As the position of the repeated pattern region 3 computed by the control portion 46 is computed based on CAD data, etc. used when forming the patterns on the wafer 22, an error may occur between the position thus computed and the position on the image data captured by the imaging portion 20, because of the effects of the previously described apparatus errors. The X-direction tentative region is set inside the repeated pattern region 3 given from the control portion 46, by providing a margin with respect to each edge of the region 3 to ensure that the tentative region will invariably lie inside the repeated pattern region 3 despite the occurrence of the above error. The margin is determined according to the mechanical accuracy of the stage 21, etc.

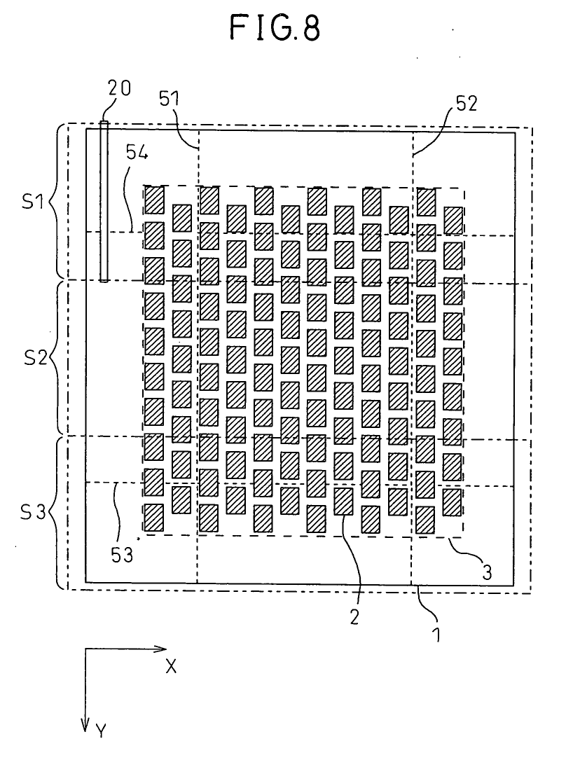

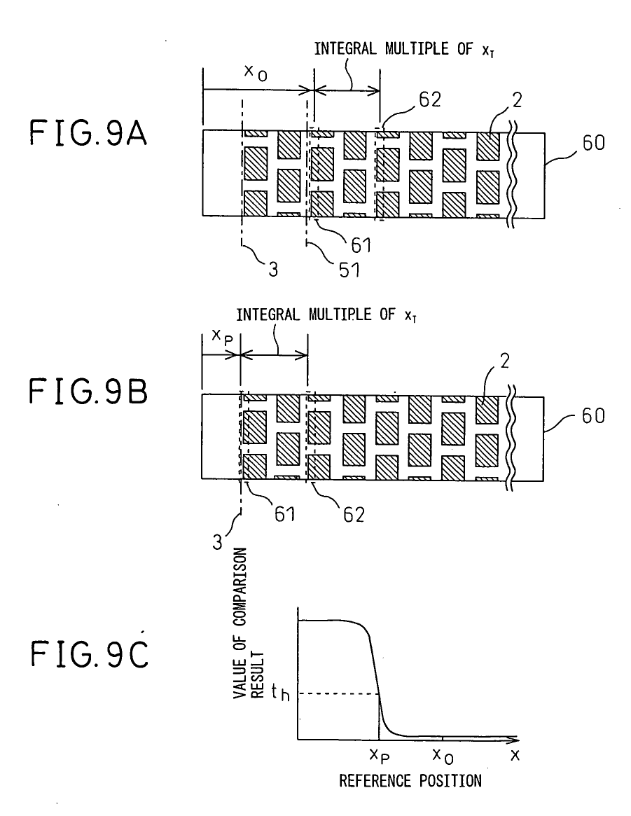

In step S133, the imaging portion 20 is operated to scan the die 1 to capture the image of the pattern formed thereon. For convenience of explanation, an X-axis and a Y-axis are set on the surface of the wafer 22, the former along the scanning direction of the imaging means 20 and the latter along a direction at right angles to the scanning direction. The scanning by the imaging means 20 is performed in a number of steps according to its image capturing size (the number of devices whose images are to be captured simultaneously) and the size of the die 1. In the example of FIG. 8, each die 1 is scanned in three steps S1 to S3. The captured image signal is converted by the A/D converter 23 into a digital signal which is stored in the image memory 24. The image signal 60 acquired in a single scanning step and stored in the image memory 24 is shown in FIG. 9A.

In step S135, the reference position which is judged whether it should be contained in the inspection region is set inside the X-direction tentative region. In the illustrated example, the reference position is set at a distance X₀ from the edge of the die 1.

In step S137, a pixel column block 61 located at the reference position in the captured image is compared with a pixel column block 62 located an integral multiple of repeat pitchs (x_{T}) away from the reference position. In the pixel block comparison, the grayscale values of the corresponding pixels in the respective pixel blocks are compared with each other, and a count of the number of pixels found to have a grayscale value difference greater than a predetermined inter-pixel comparison threshold value is taken as the result of the comparison.

In step S139, the value of the comparison result is compared with a predetermined threshold pixel count value tₕ. As the reference position is currently located inside the X-direction tentative region (step S137), the pixel column block 61 and the pixel column block 62 are both located inside the repeated pattern region 3, which means that the captured images of the two blocks represent the same portion of the repeated pattern 2. As a result, the value of the comparison result is small as shown in FIG. 9C, that is, smaller than the predetermined threshold value.

In step S141, the reference position is moved by a fine increment of Δx outwardly toward the boundary of the repeated pattern region 3, after which the process proceeds to step S137. As the result of the comparison shows a value not greater than the predetermined threshold value until the reference position reaches the position xₚ located at the boundary of the repeated pattern region 3, the process from step S137 to S141 is repeated.

FIG. 9B is a diagram showing the state in which the reference position has reached the position xₚ located at the boundary of the repeated pattern region 3. Here, when the pixel column block 61 located at the reference position in the captured image is compared in step S137 with the pixel column block 62 located an integral multiple of repeat pitch (x_{T}) away from the reference position, as the reference position is located at the boundary of the repeated pattern region 3, the value of the comparison result rapidly increases upon reaching the boundary, and exceeds the predetermined threshold value tₕ as shown in FIG. 9C.

Therefore, in step S139, it is determined that the value of the comparison result has exceeded the predetermined threshold value tₕ, and the position defined by (present reference position−prescribed shift amount Δx) is set as the inspection region boundary (step S143).

In this case, in the position xₚ at which the result of the comparison between the pixel column block 61 located at the reference position in the captured image and the pixel column block 62 located an integral multiple of repeat pitch (x_{T}) away from the reference position exceeds the threshold value tₕ, a small amount of noise may be contained in the image of the pixel column block 61; accordingly, the position displaced inwardly of the pattern region 3 by a prescribed number of pixels from the position xₚ may be determined as the actual inspection region boundary.

After that, in step S145, the die comparing portion 25 performs the die-to-die comparison based on the image signal outside the determined inspection region, and the cell comparing portion 26 performs the cell-to-cell comparison based on the image signal inside the determined inspection region.

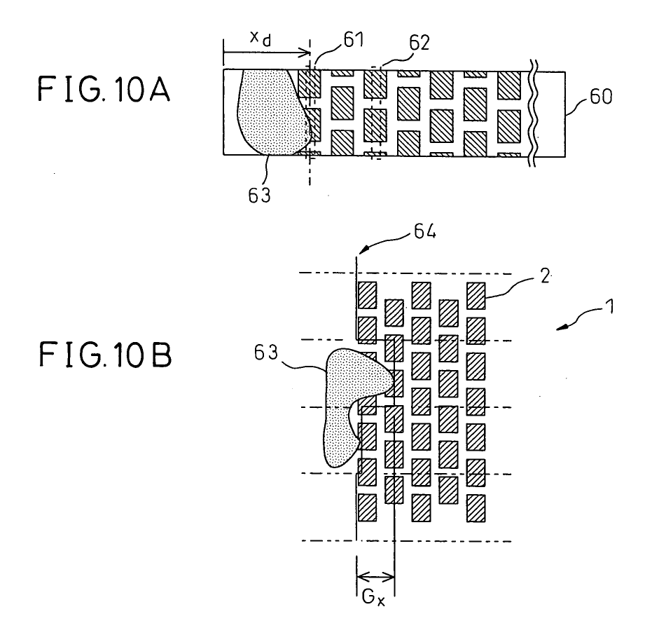

If there is a defect 63 near the boundary of the pattern region 3 as shown in FIG. 10A, the result of the comparison between the pixel column block 61 located at the reference position in the captured image and the pixel column block 62 located an integral multiple of repeat pitches away from the reference position exceeds the threshold value tₕ before the reference position reaches the boundary of the pattern region 3, and as a result, the boundary of the inspection region is set at a position x_{d} inward of the boundary of the pattern region 3.

Accordingly, when there is such a defect 63 near the boundary of the pattern region 3, the boundary of the inspection region varies depending on the scanning position of the imaging portion 20 (in the example of FIG. 8, depending on whether the scanning position is S1, S2, or S3), and the finally set inspection region has a boundary as shown by a continuous line 64 in FIG. 10B. Therefore, the presence of the defect 63 located at the boundary of the pattern region 3 can be detected by computing the difference Gₓ of the inspection region boundary position between the respective scanning positions or the difference between the thus set boundary position of the inspection region and the given boundary position of the pattern region 3 or the boundary position of the X-direction tentative region.

The inspection region setting portion 43 outputs the boundary position of the inspection region thus set for each scanning position, and the boundary position is supplied via the inspection region output portion 45 to the control portion 46 which has a display device. Further, when the difference Gₓ of the inspection region boundary position, or the difference between the thus set boundary position of the inspection region and the given boundary position of the pattern region 3 or the boundary position of the X-direction tentative region, is greater than a predetermined value, the inspection region setting portion 43 instructs the error output portion 44 to produce an error output to the control portion 46, or sends a defect output signal to the result output portion 28.

As described above, the inspection region setting portion 43 can set the inspection region boundary on the cell-to-cell comparison start side if it is at least supplied with an image signal for a width equal to (the distance from the edge of the die 1 to the tentative region boundary 51+one repeat pitch length (x_{T}) of the repeated pattern). Accordingly, provisions may be made for the inspection region setting portion 43 to start the inspection region setting process immediately after acquiring the necessary amount of image signal even when the acquisition of the entire scanned image 60 for one scan is not completed yet.

As shown in FIG. 9C, when the reference position is incrementally shifted in one prescribed direction outwardly (or inwardly) toward the boundary of the pattern region 3, the value of the comparison result abruptly changes (increases) when the reference position reaches the position xₚ at the boundary of the repeated pattern region 3.

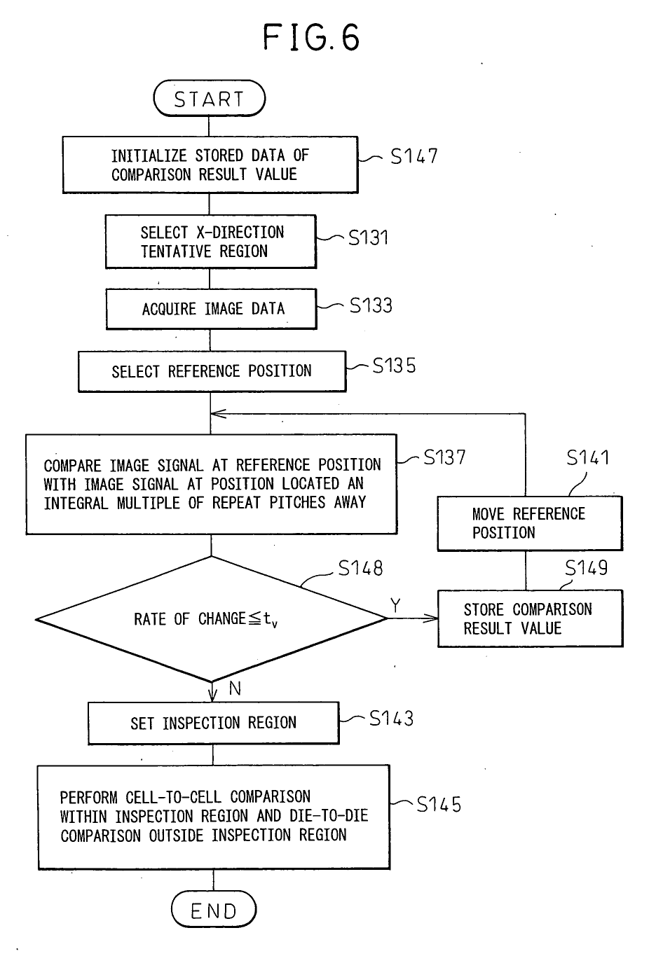

Accordingly, in the flowchart shown in FIG. 5, instead of determining in step S139 that the value of the comparison result has exceeded the predetermined threshold value tₕ, and setting in step S143 the reference position as the boundary of the inspection region when the value of the comparison result has exceeded the predetermined threshold value tₕ, a determination may be made as to whether the amount of change or rate of change between the result of the comparison performed in the previous loop and the result of the comparison performed in the present loop exceeds a predetermined threshold value and, when this amount of change or rate of change exceeds the predetermined threshold value, the present reference position may be set as the boundary of the inspection region. FIG. 6 shows a flowchart of the pattern comparison inspection method according to the first embodiment of the present invention, for explaining such an operation of the pattern comparison inspection apparatus 10.

In step S147, the contents of a storing portion for storing the previous comparison result are initialized. This storing portion is used to compare the previous comparison result with the present comparison result and compute the amount of change or rate of change between the comparison results.

Then, as in the pattern comparison inspection method shown in FIG. 5, the X-direction tentative region is set in step S131, an image of the pattern formed on the die 1 is captured in step S133 by scanning the die 1 with the imaging portion 20, the reference position which is judged whether it should be contained in the inspection region is set inside the X-direction tentative region in step S135, and the pixel column block 61 located at the reference position is compared in step S137 with the pixel column block 62 located an integral multiple of repeat pitch (x_{T}) away from the reference position.

In step S148, the amount of change or rate of change between the comparison result stored in the storing portion (the comparison result obtained in step S137 in the previous loop) and the comparison result obtained in step S137 (in the present loop) is computed, and it is determined whether the amount of change or rate of change between the comparison results is greater than a predetermined threshold value tᵥ. If the amount of change or rate of change between the comparison results is not greater the predetermined threshold value tᵥ, then in step S149 the comparison result obtained in step S137 is stored in the storing portion for computation of the amount of change or rate of change for the next time, and in step S141, the reference position is shifted outwardly toward the boundary of the repeated pattern region 3. After that, the process returns to step S137, to repeat the steps S137, S148, S149, and S141.

If the result of the determination in step S148 shows that the amount of change or rate of change between the comparison results is greater than the predetermined threshold value tᵥ, then, in step S143, the inspection region is determined by setting the present reference position as the boundary of the inspection region. After that, in step S145, the die comparing section 25 performs the die-to-die comparison based on the image signal outside the determined inspection region, and the cell comparing section 26 performs the cell-to-cell comparison based on the image signal inside the determined inspection region.

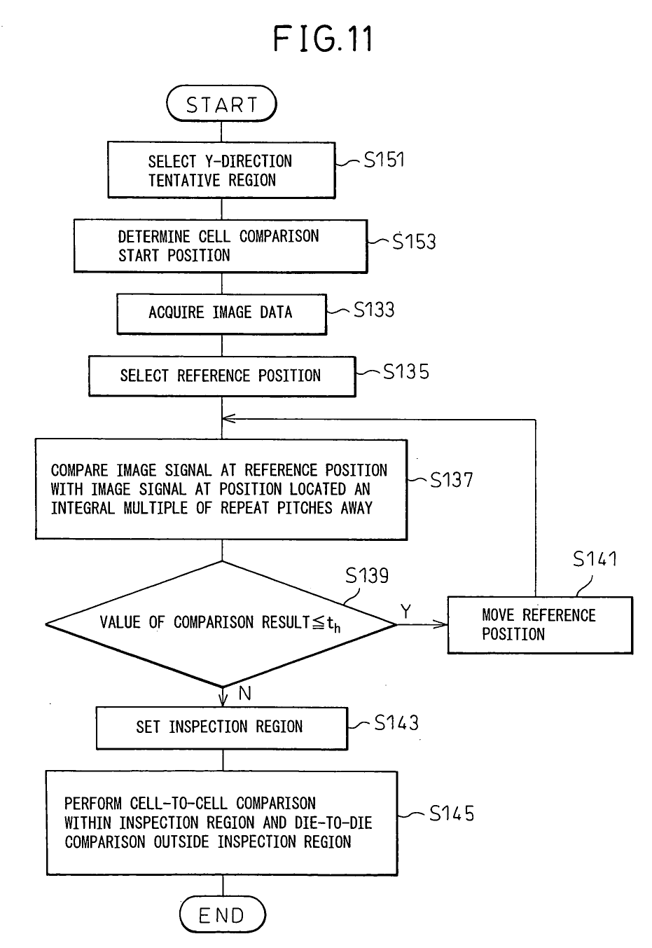

In the method shown in FIG. 5, the inspection region has been enlarged in the scanning direction (X direction) of the imaging means 20; on the other hand, when the image data acquired by the imaging means 20 contains the boundary positions of the pattern region 3 in the Y direction, such as the image data obtained, for example, in the scanning positions S1 and S3 shown in FIG. 8, the inspection region can also be enlarged in the direction (Y direction) at right angles to the scanning direction of the imaging means 20. FIG. 11 shows the flowchart for that case.

In step S151, a Y-direction tentative region bounded by boundary lines 53 and 54 is set in relationship to the repeated pattern region 3 as shown in FIG. 7. The Y-direction tentative region, like the X-direction tentative region, is set inside the repeated pattern region 3 by providing a margin with respect to each edge thereof.

When the image data acquired by the imaging portion 20 contains the boundary positions of the pattern region 3 in the Y direction (for example, when the scanning is done along the scanning position S1 shown in FIG. 8), then in step S153 the inspection region boundary 64 at which the cell-to-cell comparison is to be started in the X direction is determined in accordance with the method of FIG. 5. In this case, the boundary may be determined after the entire scanned image 60 for one scan has been acquired and stored in the image memory 24, or alternatively, to improve the inspection throughput, the inspection region boundary on the cell-to-cell comparison start side may be set when an image signal for a width equal to (the distance from the edge of the die 1 to the tentative region boundary 51+one repeat pitch length (x_{T}) of the repeated pattern) has been acquired.

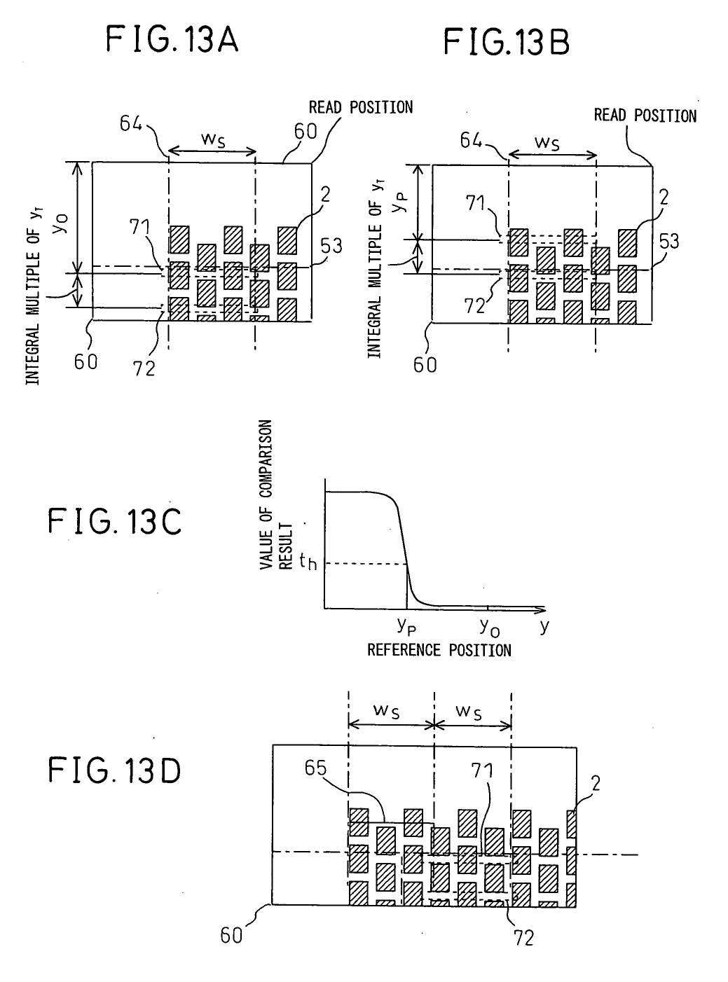

After waiting for image data having a prescribed pixel column width wₛ from the boundary 64 of the X-direction inspection region at which the cell-to-cell comparison is to be started, to be captured, the image data is acquired in step S133. An image signal 60 of the image data having the prescribed pixel column width wₛ is shown in FIG. 13A. The Y-direction inspection region is sequentially set for every pixel column width wₛ.

In step S135, the reference position which is judged whether it should be contained in the inspection region is set inside the Y-direction tentative region. In the illustrated example, the reference position is set at a distance y₀ from the edge of the die 1.

In step S137, a pixel column block 71 located at the reference position in the captured image is compared with a pixel column block 72 located an integral multiple of repeat pitch (y_{T}) away from the reference position. In step S139, the value of the comparison result is compared with a predetermined threshold value tₕ. As the reference position is currently located inside the Y-direction tentative region (step S135), the value of the comparison result is smaller than the threshold value, as shown in FIG. 13C.

In step S141, the reference position is moved by a fine increment of Δy outwardly toward the boundary of the repeated pattern region 3, after which the process proceeds to step S137. The process from step S137 to S141 is repeated until the reference position reaches the position yₚ located at the boundary of the repeated pattern region 3.

FIG. 13B is a diagram showing the state in which the reference position has reached the position yₚ located at the boundary of the repeated pattern region 3. Here, when the pixel column block 71 located at the reference position in the captured image is compared in step S137 with the pixel column block 72, as the reference position is located at the boundary of the repeated pattern region 3, the value of the comparison result rapidly increases upon reaching the boundary, and exceeds the predetermined threshold value tₕ as shown in FIG. 13C.

Therefore, in step S139, it is determined that the value of the comparison result has exceeded the predetermined threshold value tₕ, and the position defined by (present reference position−prescribed shift amount Δy) is set as the inspection region boundary 65, as shown in FIG. 13D (step S143). In this case, in the position yₚ at which the result of the comparison between the pixel column block 71 located at the reference position in the captured image and the pixel column block 72 located an integral multiple of repeat pitch (y_{T}) away from the reference position exceeds the threshold value tₕ, a small amount of noise may be contained in the image of the pixel column block 71; accordingly, the position displaced inwardly of the pattern region 3 by a prescribed number of pixels from the position yₚ may be determined as the actual inspection region boundary.

As the scanning by the imaging means 20 progresses, and new image data having a pixel column width wₛ is acquired, the process from step S133 to step S143 is repeated to sequentially set the Y-direction inspection region. Alternatively, the process from step S133 to step S143 may be carried out only once and only for the data having the width wₛ starting from the boundary 64 of the X-direction inspection region, and the Y-direction inspection region obtained here may be determined as the inspection region for the entire scanned image.

After that, in step S145, as the image data necessary for comparison is captured, the die comparing portion 25 sequentially performs the die-to-die comparison based on the image signal outside the determined inspection region, and the cell comparing portion 26 performs the cell-to-cell comparison based on the image signal inside the determined inspection region.

As shown in FIG. 13C, when the reference position is incrementally shifted in one prescribed direction outwardly (or inwardly) toward the boundary of the pattern region 3, the value of the comparison result abruptly changes (increases) when the reference position reaches the position yₚ at the boundary of the repeated pattern region 3.

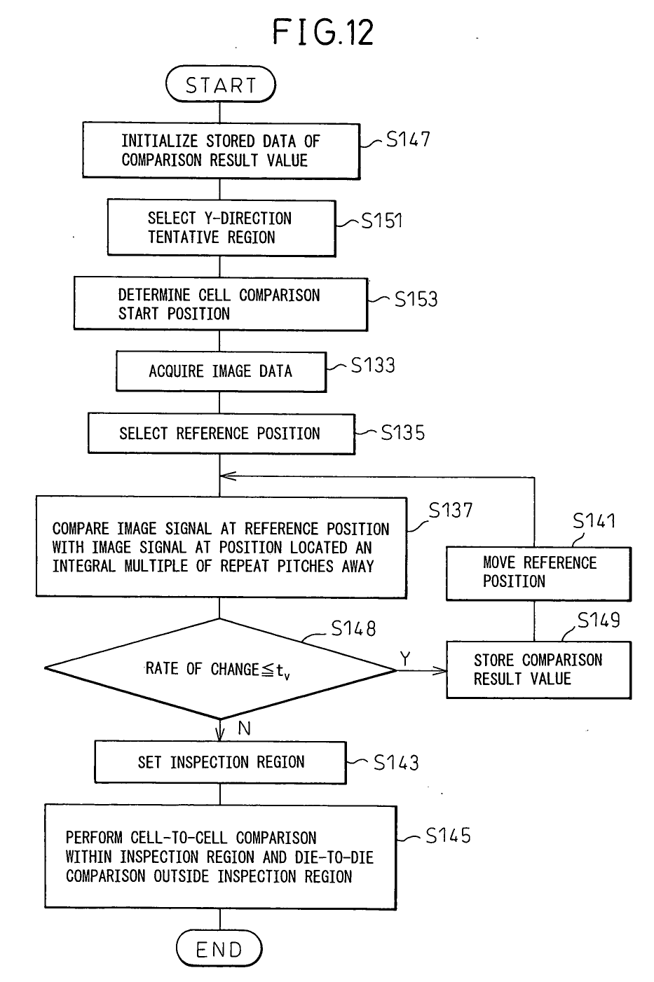

Accordingly, in the flowchart shown in FIG. 11, instead of determining in step S139 that the value of the comparison result has exceeded the predetermined threshold value tₕ, and setting in step S143 the reference position as the boundary of the inspection region when the value of the comparison result has exceeded the predetermined threshold value tₕ, a determination may be made as to whether the amount of change or rate of change between the result of the comparison performed in the previous loop and the result of the comparison performed in the present loop exceeds a predetermined threshold value and, when this amount of change or rate of change exceeds the predetermined threshold value, the present reference position may be set as the boundary of the inspection region. FIG. 12 shows a flowchart of the pattern comparison inspection method according to the first embodiment of the present invention, for explaining such operation of the pattern comparison inspection apparatus 10.

In step S147, the contents of a storing portion for storing the previous comparison result are initialized. This storing portion is used to compare the previous comparison result with the present comparison result and compute the amount of change or rate of change between the comparison results.

Then, as in the pattern comparison inspection method shown in FIG. 11, the Y-direction tentative region is set in step S151, the inspection region boundary 64 at which the cell-to-cell comparison is to be started in the X direction is determined in step S153 in accordance with the method of FIG. 5, an image of the pattern formed on the die 1 is captured in step S133 by scanning the die 1 with the imaging portion 20, the reference position which is judged whether it should be contained in the inspection region is set inside the Y-direction tentative region in step S135, and the pixel column block 71 located at the reference position is compared in step S137 with the pixel column block 72 located an integral multiple of repeat pitch (y_{T}) away from the reference position.

In step S148, the amount of change or rate of change between the comparison result stored in the storing portion (the comparison result obtained in step S137 in the previous loop) and the comparison result obtained in step S137 (in the present loop) is computed, and it is determined whether the amount of change or rate of change between the comparison results is not greater than a predetermined threshold value tᵥ. If the amount of change or rate of change between the comparison results is not greater than the predetermined threshold value tᵥ, then in step S149 the comparison result obtained in step S137 is stored in the storing portion for computation of the rate of change for the next time, and in step S141, the reference position is shifted outwardly toward the boundary of the repeated pattern region 3. After that, the process returns to step S137, to repeat the steps S137, S148, S149, and S141.

If the result of the determination in step S148 shows that the rate of change between the comparison results is greater than the predetermined threshold value tᵥ, then, in step S143, the inspection region is determined by setting the present reference position as the boundary of the inspection region. After that, in step S145, the die comparing portion 25 performs the die-to-die comparison based on the image signal outside the determined inspection region, and the cell comparing portion 26 performs the cell-to-cell comparison based on the image signal inside the determined inspection region.

Here, in step S148, instead of determining whether the amount or rate of change of the comparison result is not greater than the predetermined threshold value tᵥ, it may be determined whether or not the amount or rate of change of the comparison result becomes maximum and, if the amount or rate of change of the comparison result is maximum, the present reference position may be set as the boundary of the inspection region in step S143. For this purpose, the storing portion may be configured to store the largest value among the amounts or rates of change of the comparison results computed in the past loops, in addition to the comparison result obtained in the previous loop (S137, S148, S149, and S141). Then, in step S149, when storing the comparison result obtained in S137, it may be determined whether the amount or rate of change of the comparison result, computed in step S148, exceeds the largest value of the amount or rate of change of the comparison result stored in the storing portion and, if it exceeds the largest value, then the largest value of the amount or rate of change of the comparison result, stored in the storing portion, may be updated accordingly.

When setting the Y-direction inspection region, a scanned image having a certain width must be acquired for setting. For example, in FIG. 13A-13D, if the inspection region is to be enlarged up to the boundary 3 of the repeated pattern region by comparing the pixel column block 71 located at the reference position in the captured image with the pixel column block 72 located an integral multiple of repeat pitch (y_{T}) away from the reference position, an image must be captured that has a width not smaller than (the distance from the boundary 3 of the repeated pattern region to the boundary 53 of the tentative region+one repeat pitch length (y_{T}) of the repeated pattern).

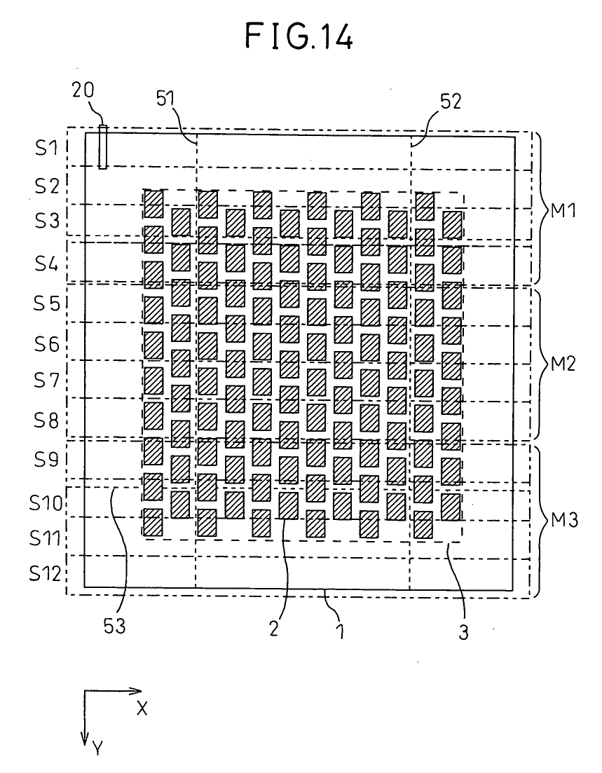

Accordingly, when setting the Y-direction inspection region, a sensor capable of capturing an image having the above-defined width at a time must be used as the imaging portion 20. Alternatively, as shown in FIG. 14, images obtained by scanning a plurality of times ((the distance from the boundary 3 of the repeated pattern region to the boundary 53 of the tentative region+one repeat pitch length (y_{T}) of the repeated pattern)÷width per scan) may be stored together in the image memory 24 to create a combined image having the above-defined width. In the example of FIG. 14, though the image capturing width of the imaging device 20 is small, images obtained by scanning four times in the respective scanning sections S1 to S4, S5 to S8, and S9 to S12 can be stored as image data M1, M2, and M3, respectively, in the image memory 24.

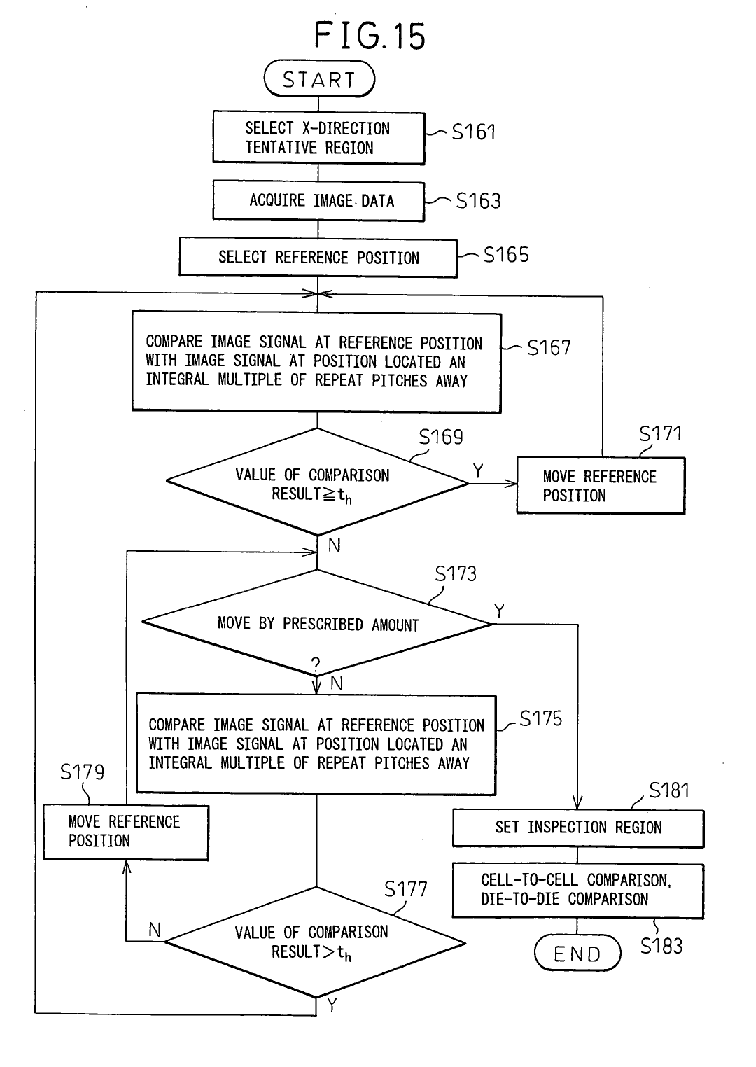

FIG. 15 shows a flowchart of a pattern comparison inspection method according to a second embodiment of the present invention. In the pattern comparison inspection method according to the second embodiment of the present invention, the respective boundaries 51 and 52 and 53 and 54 of the X-direction tentative region and the Y-direction tentative region are set outside the repeated pattern region 3. The overall configuration of the pattern comparison inspection apparatus implementing the pattern comparison inspection method according to the second embodiment of the present invention is the same as that of the pattern comparison inspection apparatus 10 shown in FIG. 4; therefore, neither an illustration of the configuration nor a description of each constituent element will be repeated herein.

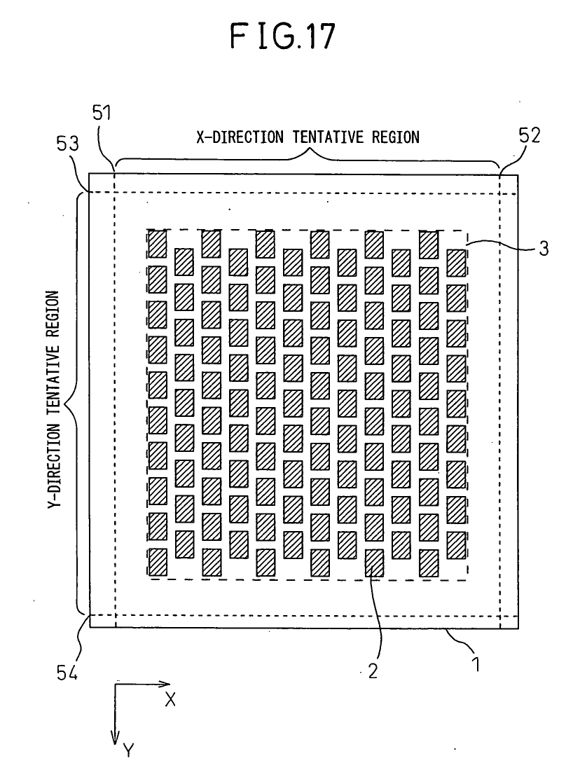

In step S161, the X-direction tentative region bounded by the boundary lines 51 and 52 shown in FIG. 17 is set in relationship to the repeated pattern region 3. Further, the Y-direction tentative region bounded by the boundary lines 53 and 54 is set in relationship to the repeated pattern region 3. The boundary lines of each tentative region are set outside the repeated pattern region 3 given from the control portion 46, by providing a margin with respect to the respective edges of the region 3 as previously described.

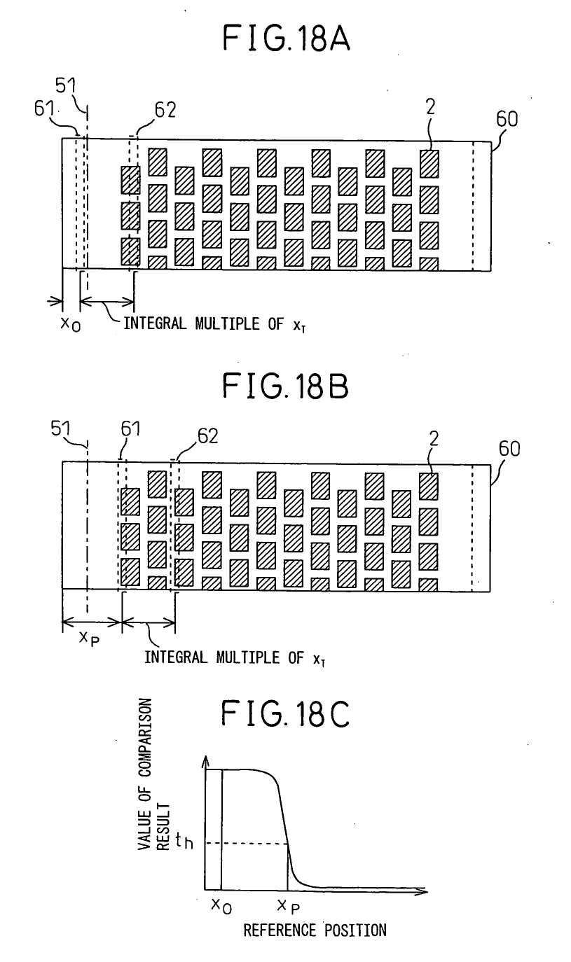

In step S163, an image of the pattern formed on the die 1 is captured by scanning the die 1 with the imaging portion 20. The captured image signal 60 is shown in FIG. 18A.

In step S165, the reference position at which it is judged whether it should be contained in the inspection region is set outside each of the X- and Y-direction tentative regions. In the illustrated example, the reference position for the X direction is set at a distance X₀ from the edge of the die 1.

In step S167, the pixel column block 61 located at the reference position in the captured image is compared with the pixel column block 62 located an integral multiple of repeat pitch (x_{T}) away from the reference position. At this time, the multiple of repeat pitch (x_{T}) is set in advance according to the margin so that the pixel column block 62 is located inside the repeated pattern region 3.

In step S169, the value of the comparison result is compared with a predetermined threshold pixel count value tₕ. As the reference position is currently located outside the X-direction tentative region (step S165), the pixel column block 61 is outside the repeated pattern region 3. Accordingly, when the pixel column block 61 is compared with the pixel column block 62 located inside the repeated pattern region 3, the value of the comparison result is large as shown in FIG. 18C, that is, larger than the predetermined threshold value tₕ.

In step S171, the reference position is moved by a fine increment of Δx inwardly toward the repeated pattern region 3, after which the process proceeds to step S167. As the value of the comparison result remains larger than the predetermined threshold value until the reference position reaches the position xₚ located at the boundary of the repeated pattern region 3, the process from step S167 to S171 is repeated.

FIG. 18B is a diagram showing the state in which the reference position has reached the position xₚ located at the boundary of the repeated pattern region 3. Here, when the pixel column block 61 located at the reference position in the captured image is compared in step S167 with the pixel column block 62 located an integral multiple of repeat pitch (x_{T}) away from the reference position, as the reference position is located at the boundary of the repeated pattern region 3, the value of the comparison result rapidly decreases upon reaching the boundary, and drops below the predetermined threshold value tₕ as shown in FIG. 18C.

Therefore, it is determined that the value of the comparison result has droped below the predetermined threshold value tₕ, and thus the position defined by (present reference position−prescribed shift amount Δx) can be identified as the inspection region boundary. In this case, as in the case of the methods previously described with reference to FIGS. 6 and 12, the position displaced inwardly of the pattern region 3 by a prescribed number of pixels from the position xₚ may be determined as the actual inspection region boundary, the position xₚ being the position at which the result of the comparison between the pixel column block 61 located at the reference position in the captured image and the pixel column block 62 located an integral multiple of repeat pitch (x_{T}) away from the reference position drops below the threshold value tₕ.

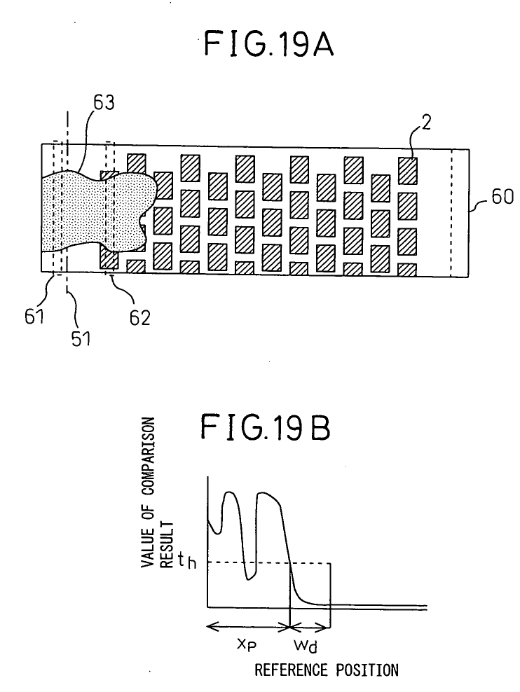

However, account has to be taken here of the possible occurrence of a situation such as shown in FIG. 19A. FIG. 19A shows the case where there is a defect 63 near the boundary of the repeated pattern region 3. In the case of such image data, the previously described method that sets the tentative region inside the repeated pattern region 3 simply ends up reducing the inspection region as explained with reference to FIGS. 10A and 10B; however, in the case of the method that sets the tentative region outside the repeated pattern region 3 and detects the boundary of the repeated pattern region 3 by working inwardly, as in the present embodiment, there is the possibility that the inspection region may be erroneously set outwardly of the repeated pattern region 3. That is, in the presence of such a defect 63, there is the possibility that, as shown in FIG. 19B, the value of the comparison result may drop below the threshold value tₕ when the measuring position being moved is still outside the repeated pattern region 3.

Therefore, after further moving the reference position by a prescribed amount w_{d} and confirming that the value of the comparison result does not exceed the threshold value tₕ (S173 to S179), the reference position at which the value of the comparison result dropped below the predetermined threshold value tₕ is set as the boundary of the inspection region (S181).

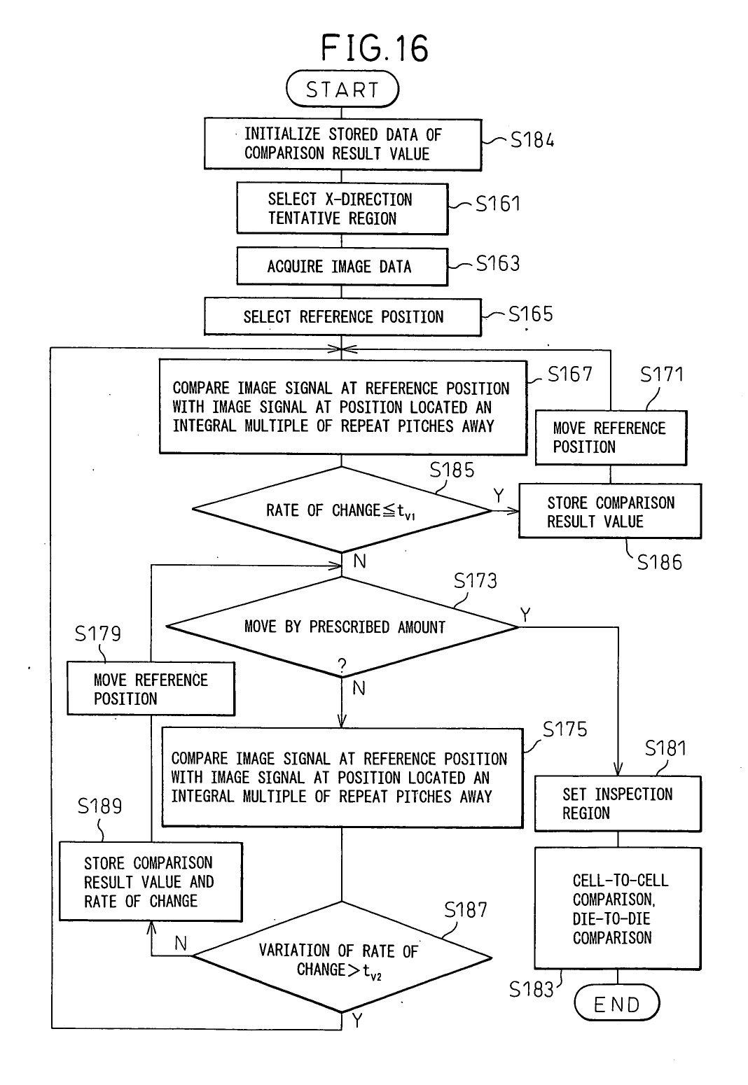

As in the methods previously described with reference to FIGS. 6 and 12, instead of determining in step S169 in the method of FIG. 15 that the value of the comparison result has dropped below the predetermined threshold value tₕ, and setting the reference position as the boundary of the inspection region when the value of the comparison result has dropped below the predetermined threshold value tₕ, a determination may be made as to whether the amount of change or rate of change between the result of the comparison performed in the previous loop and the result of the comparison performed in the present loop exceeds a predetermined threshold value and, when this amount of change or rate of change exceeds the predetermined threshold value, the present reference position may be set as the boundary of the inspection region. FIG. 16 shows a flowchart of the pattern comparison inspection method according to the second embodiment of the present invention, for explaining such operation of the pattern comparison inspection apparatus 10.

In step S184, the contents of a storing portion for storing the previous comparison result are initialized. This storing portion is used to compare the previous comparison result with the present comparison result and compute the amount of change or rate of change between the comparison results.

Then, in step S161, the X-direction tentative region and the Y-direction tentative region are set in relationship to the repeated pattern region 3, as in the flowchart shown in FIG. 15. In step S163, an image of the pattern formed on the die 1 is captured by scanning the die 1 with the imaging means 20.

In step S165, the reference position which is judged whether it should be contained in the inspection region is set outside each of the X- and Y-direction tentative regions. For example, in the case of the X direction, the reference position is set at a distance X₀ from the edge of the die 1. In step S167, the pixel column block 61 located at the reference position in the captured image is compared with the pixel column block 62 located an integral multiple of repeat pitch (x_{T}) away from the reference position.

In step S185, the amount of change or rate of change between the comparison result stored in the storing portion (the comparison result obtained in step S167 in the previous loop) and the comparison result obtained in step S167 (in the present loop) is computed, and it is determined whether the amount of change or rate of change between the comparison results is not greater than a predetermined threshold value tᵥ₁. If the amount of change or rate of change between the comparison results is not greater than the predetermined threshold value tᵥ₁, then in step S186 the comparison result obtained in step S167 is stored in the storing portion for computation of the amount of change or rate of change for the next time, and in step S171, the reference position is shifted inwardly toward the repeated pattern region 3. After that, the process returns to step S167, to repeat the steps S167, S185, S186, and S171.

If the result of the determination in step S185 shows that the rate of change between the comparison results is greater than the predetermined first threshold value tᵥ₁, the reference position is further moved by a prescribed amount w_{d} (S173), and the image signal at the reference position is compared with the image signal at the position located an integral multiple of the repeat pitch away from the reference position (S175).

Then, while the reference position is being moved in step S173, the amount of change or rate of change between the result of the above comparison and the comparison result stored in the storing portion is computed and, after confirming that the amount of variation of the rate of change does not exceed a second threshold value tᵥ₂ (S187, S189, and S179), the reference position at which the value of the comparison result exceeded the predetermined threshold value tᵥ₁ is set as the inspection region boundary (S181).

After that, in step S183, the die comparing portion 25 performs the die-to-die comparison based on the image signal outside the determined inspection region, and the cell comparing portion 26 performs the cell-to-cell comparison based on the image signal inside the determined inspection region.

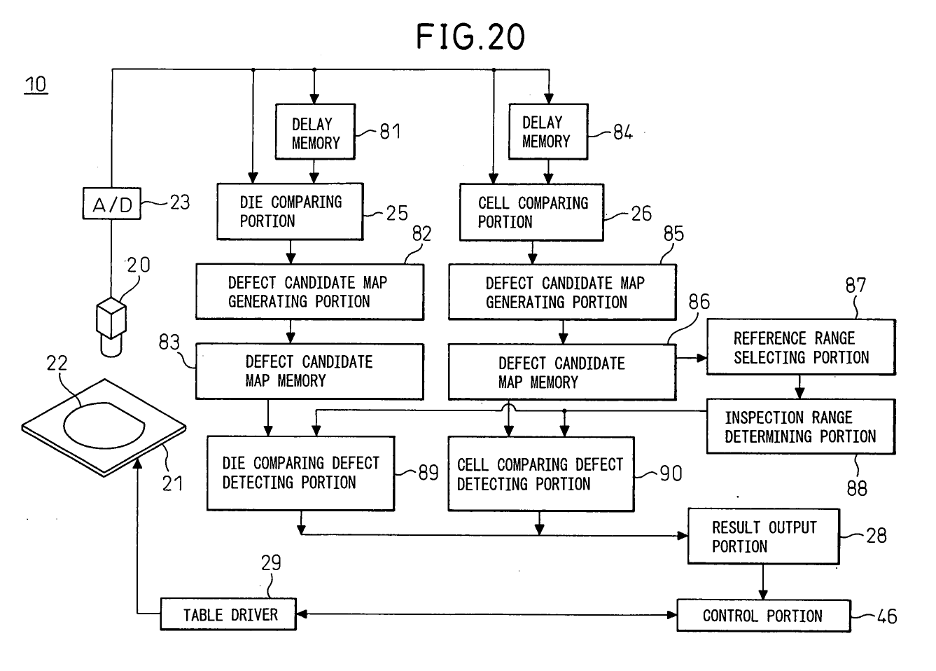

FIG. 20 is a diagram schematically showing the configuration of a pattern comparison inspection apparatus according to a third embodiment of the present invention. The pattern comparison inspection apparatus 10 of this embodiment captures an image of a circuit pattern or the like that is formed on a wafer 22 and that contains a repeated pattern region such as a memory cell region, and compares a given threshold value with a difference value taken between two pixels located at positions separated from each other by an integral multiple of the repeat pitch in the captured image. Then, a defect candidate map is generated by taking any pixel for which the difference is larger than the threshold value as a defect candidate; next, in the entire range of the defect candidate map, a region where the frequency of occurrence of such defect candidates is lower than a predetermined frequency is determined as the repeated pattern region, while a region where the frequency is higher is determined as a region outside the repeated pattern region, and the defect inspection is performed only within the thus determined repeated pattern region.

Since the frequency of occurrence of defect candidates is far higher outside the repeated pattern region than within the repeated pattern region, the inspection region can be determined properly in the above manner.

The pattern comparison inspection apparatus 10 comprises: a stage 21 for holding thereon the wafer 22 on which circuit patterns or the like containing repeated patterns of memory cells, etc. are formed; an imaging portion 20, such as a one-dimensional image sensor, for capturing an image of the patterns formed on the wafer 22; and a stage controller 29 for moving the stage 21 so that the wafer 22 is scanned by the imaging portion 20 in order for the imaging portion 20 to capture the image of the patterns across the entire surface of the wafer 22.

The pattern comparison inspection apparatus 10 further comprises: an A/D converter 23 which converts the captured analog image signal into an image signal in digital form; a delay memory 81 which delays the analog-to-digital converted image signal by an amount equal to the repeat pitch of the dies formed on the wafer 22; a die comparing portion 25 as a defect candidate detecting portion which obtains the difference value between the image signal output from the A/D converter 23 and the image signal delayed by the delay memory 81, and which detects any pixel for which the difference value is larger than a predetermined threshold value as a defect candidate; a defect candidate map generating portion 82 which, based on the defect candidate detection results from the die comparing portion 25, generates a die comparing defect candidate map that indicates the location of each defect candidate in the captured image of the wafer 22; and a defect candidate map memory 83 which stores the thus generated die comparing defect candidate map.

Further, the pattern comparison inspection apparatus 10 comprises: a delay memory 84 which delays the analog-to-digital converted image signal by an amount equal to the repeat pitch of the cells formed as repeated patterns; a cell comparing portion 26 as a defect candidate detecting portion which obtains the difference value between the image signal output from the A/D converter 23 and the image signal delayed by the delay memory 84, and which detects any pixel for which the difference value is larger than a predetermined threshold value V₁ as a defect candidate; a defect candidate map generating portion 85 which, based on the defect candidate detection results from the cell comparing portion 26, generates a cell comparing defect candidate map that indicates the location of each defect candidate in the captured image of the wafer 22; and a defect candidate map memory 86 which stores the thus generated cell comparing defect candidate map.

The pattern comparison inspection apparatus 10 further comprises: a reference range selecting portion 87 which selects a reference range of a prescribed size within the cell comparing defect candidate map; and an inspection range determining portion 88 which determines an inspection range by containing therein the reference range selected by the reference range selecting portion 87, if the number of defect candidates contained in the reference range or the proportion of the area occupied by the defect candidates to the total area of the reference range is smaller than a predetermined second threshold value V₂. Further, the pattern comparison inspection apparatus 10 comprises: a cell comparing defect detecting portion 90 which checks each defect candidate contained within the thus determined inspection range in the cell comparing defect candidate map to determine whether the defect candidate is a true defect or not; a die comparing defect detecting portion 89 which checks each defect candidate contained in a region outside the determined inspection range but inside the die comparing defect candidate map to determine whether the defect candidate is a true defect or not; and a result output portion 28 which outputs the detected result.

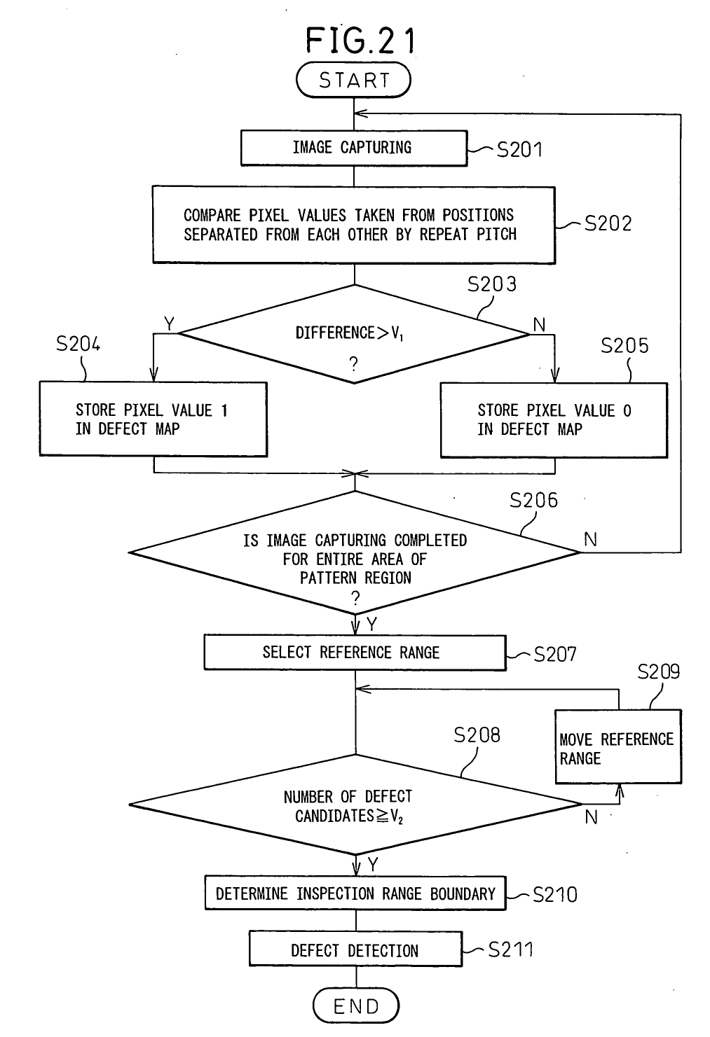

FIG. 21 is a flowchart of a pattern comparison inspection method according to the third embodiment of the present invention.

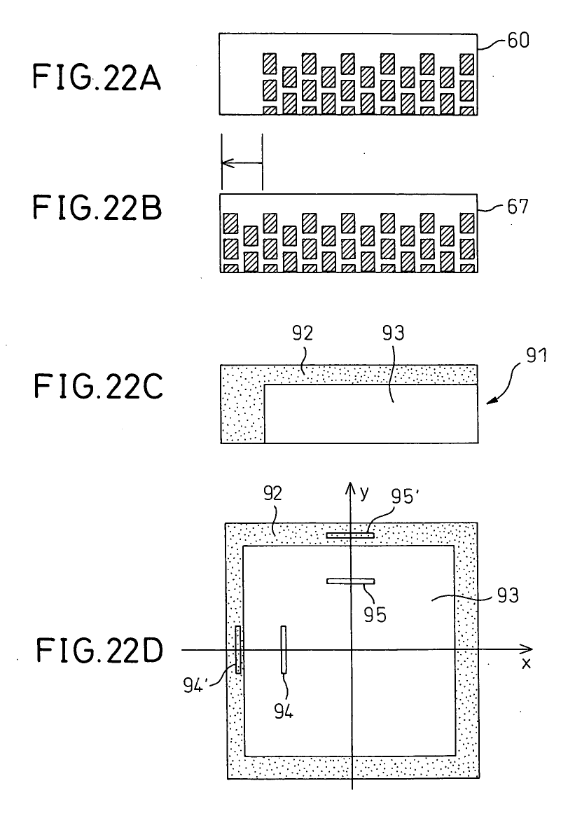

In step S201, the imaging portion 20 captures an image of the pattern formed on the wafer 22. An example of the image 60 captured by the imaging portion 20 is shown in FIG. 22A.

In step S202, the delay memory 84 delays the captured image 60 by an amount equal to the repeat pitch of the cells formed as repeated patterns. An example of the image 67 delayed by the delay memory 84 is shown in FIG. 22B. The cell comparing portion 26 computes the difference value between the image signal (the value of each pixel) output from the A/D converter 23 and the image signal delayed by the delay memory 84.

In step S203, the cell comparing portion 26 determines whether the computed difference value is larger than the predetermined threshold value V₁. If it is larger than the threshold value V₁, the defect candidate map generating portion 85 sets the pixel value in the cell comparing defect candidate map corresponding to the position of that pixel in the captured image of the wafer 22 to a “1” which indicates that the pixel is a defect candidate (S204). Conversely, if the difference value is smaller than the threshold value V₁, the pixel value in the cell comparing defect candidate map corresponding to the position of that pixel in the captured image of the wafer 22 is set to a “0” (S205).

Since the frequency of occurrence of defect candidates is far higher outside the cell region, which is the repeated pattern region, than within the cell region, the cell comparing defect candidate map obtained through the steps S201 to S205 looks like a map 91, such as shown in FIG. 22C, in which the frequency of occurrence of defect candidates is distinctly different between the cell region 93 and the outside region 92.

By performing the steps S201 to S205 over the entire area of the inspection target region for the pattern comparison inspection, the cell comparing defect candidate map for the entire area of the inspection target region is generated (FIG. 22D).

In the same manner as in the above steps S201 to S206, the delay memory 81 delays the captured image by an amount equal to the repeat pitch of the dies formed as repeated patterns, and the die comparing portion 25 computes the difference value between the image signal, i.e., the value of each pixel, output from the A/D converter 23 and the image signal delayed by the delay memory 81. Then, the defect candidate map generating portion 82 generates the die comparing defect candidate map.

In step S207, the reference range selecting portion 87 selects reference ranges 94 and 95 of prescribed size within the cell comparing defect candidate map. As examples of the reference ranges selected here, the reference range 94, which is used to determine the X-direction boundary position of the inspection range, for example, may be selected as a pixel array block having a prescribed length in the Y direction, and the reference range 95, which is used to determine the Y-direction boundary position of the inspection range may be selected as a pixel array block having a prescribed length in the X direction. The reference range selecting portion 87 selects such pixel array blocks at positions spaced a certain distance away from and within the boundary of the cell range precalculated from the CAD data, etc. used when forming the patterns on the wafer 22.

Then, in steps S208 and S209, the pixel array block 94 is incrementally shifted along the X direction outwardly toward the boundary of the cell range and, likewise, the pixel array block 95 is incrementally shifted along the Y direction outwardly toward the boundary of the cell range, until the number of defect candidates contained in the respective pixel array blocks 94 and 95 or the proportion of the area occupied by the defect candidates to the total area of the respective reference ranges becomes equal to or larger than the predetermined threshold value V₂. As earlier described, the number of defect candidates contained in each of pixel array blocks 94′ and 95′ located outside the cell range is dramatically larger than the number of defect candidates contained in the respective pixel array blocks 94 and 95 located inside the cell range; therefore, in step S210, the inspection range determining portion 88 determines the inspection range by setting the X-direction position of the pixel array block 94 as the X-direction boundary position of the cell region when the number of defect candidates contained in the pixel array block 94 or the proportion of the area occupied by the defect candidates to the total area of the reference range becomes equal to or larger than the threshold value V₂ and also setting the Y-direction position of the pixel array block 95 as the Y-direction boundary position of the cell region when the number of defect candidates contained in the pixel array block 95 or the proportion of the area occupied by the defect candidates to the total area of the reference range becomes equal to or larger than the threshold value V₂.

Then, in step S211, the cell comparing defect detecting portion 90 detects defects contained in the cell region within the thus determined inspection range in the cell comparing defect candidate map, and the die comparing defect detecting portion 89 detects defects contained in the outside-the-cell region which corresponds to the portion of the die comparing defect candidate map that lies outside the thus determined inspection range.

The reference range selecting portion 87 in step S207 may select the reference ranges at positions spaced a certain distance away from and outside the boundary of the cell range precalculated from the CAD data, etc. used when forming the patterns on the wafer 22. In that case, in step S209 the reference range selecting portion 87 may select each reference range by incrementally shifting its selection position inwardly toward the boundary of the cell range, and in steps S208 and S210 the inspection range determining portion 88 may determine the position of the reference range as the cell region boundary position when the number of defect candidates contained in the reference range or the proportion of the area occupied by the defect candidates to the total area of the reference range becomes smaller than the threshold value V₂.

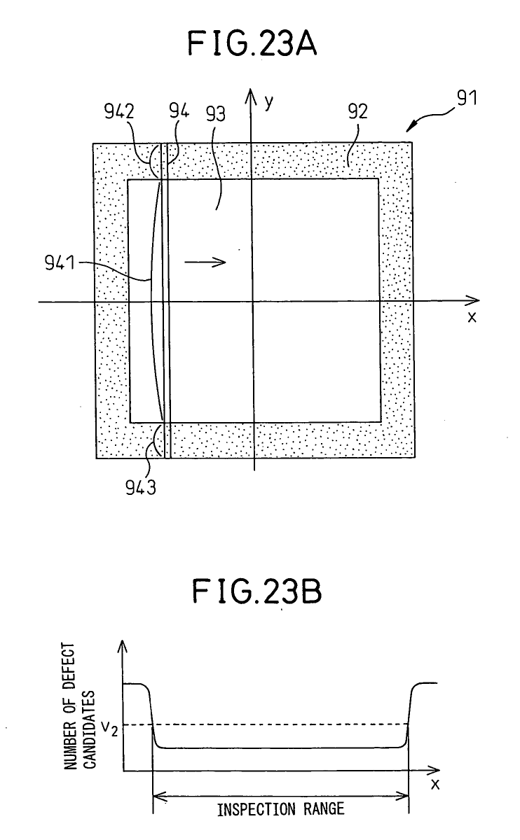

As shown in FIG. 22D, the overall longitudinal length of the reference range may be set shorter than the cell range dimension so that, when the reference range is located inside the cell range, the reference range selected by the reference range selecting portion 87 is contained in its entirety within the cell range; alternatively, provisions may be made for the reference range selecting portion 87 to select the reference range so as to always include portions outside the cell range. An example of such selection is shown in FIG. 23A.

As shown in FIG. 23A, the selection range 94 for determining the X-direction boundary is a pixel array extending longitudinally in the Y direction across the entire width of the map 91, and consists of a subrange 941 as a portion lying inside the cell range 93 and subranges 942 and 943 as portions lying outside the cell range 93. When selecting such a selection range 94 by incrementally shifting its position in the X direction, as the range 94 always includes the subranges 942 and 943 lying outside the cell range, the number of defect candidates contained in these subranges is always detected. Here, when the X-direction coordinate of the selection range 94 is located inside the cell range 93, the width of the portion 941 lying inside the cell range 93 and the width of the respective portions 942 and 943 lying outside the cell range 93 are constant and, when the X-direction coordinate is located outside the cell range 93, the width of the respective portions 942 and 943 lying outside the cell range 93 is constant; therefore, as shown in FIG. 23B, the number of defect candidates detected is distinctly different when the X-direction coordinate of the selection range 94 is located inside the cell range 93 than when it is not located inside the cell range 93. Accordingly, the boundary of the inspection range can be determined by selecting the appropriate threshold value V2 in accordance with the width of the portion 941 lying inside the cell range 93 and the width of the respective portions 942 and 943 lying outside the cell range 93 when the X-direction coordinate of the selection range 94 is located inside the cell range 93.

Further, the reference range selecting portion 87 may repeatedly select the reference range by incrementally shifting the selection position in one direction either inwardly or outwardly toward the boundary of the cell region, and in this case, the inspection range determining portion 88 may determine the inspection range based on the rate of change of the number of defect candidates contained in the reference range, that is, by setting the cell region boundary position at the position where the rate of change of the number of defect candidates exceeds a predetermined threshold value V₃.

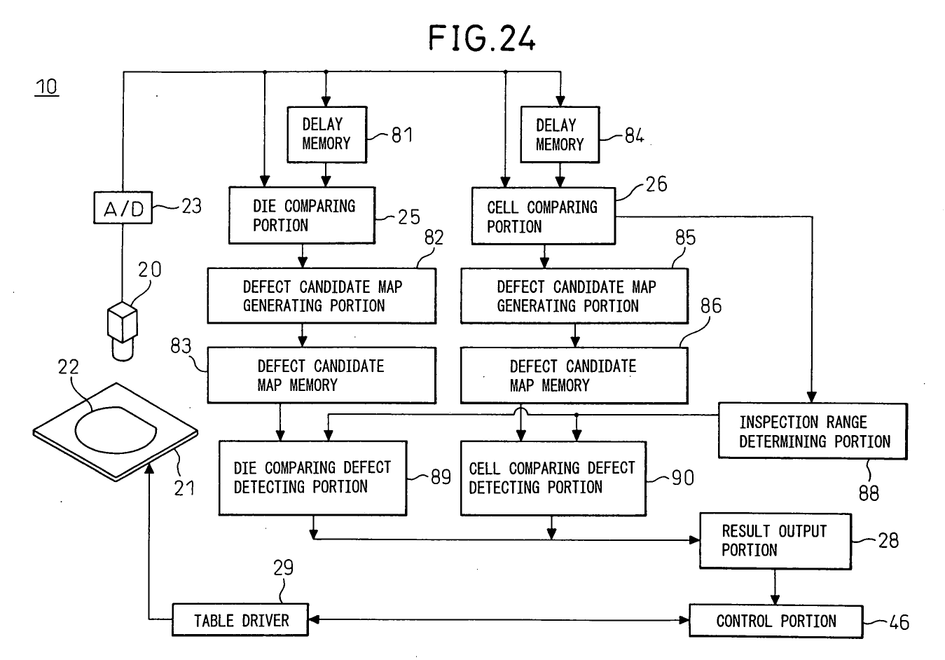

Here, generating the defect candidate map is not an essential requirement for determining the boundary of the inspection range, but the inspection range may be determined without generating or making use of the defect candidate map. FIG. 24 is a diagram schematically showing the configuration of a pattern comparison inspection apparatus according to a fourth embodiment of the present invention. The pattern comparison inspection apparatus 10 shown in FIG. 24 is similar in configuration to the pattern comparison inspection apparatus shown in FIG. 20, and the same component elements are designated by the same reference numerals and the description thereof will not be repeated here.

In this embodiment, the inspection range determining portion 88 counts the number of defect candidates detected by the cell comparing portion 26 for each X-direction pixel array and each Y-direction pixel array in the captured image of the repeated pattern region, and stores the counts as an X-direction one-dimensional array and a Y-direction one-dimensional array, respectively. Then, in each pixel array, any position where the number of defect candidates is not larger than a predetermined threshold value V₂ is determined as being located inside the inspection range, and any position where the number of defect candidates is larger than the predetermined threshold value V₂ is determined as being located outside the inspection range.

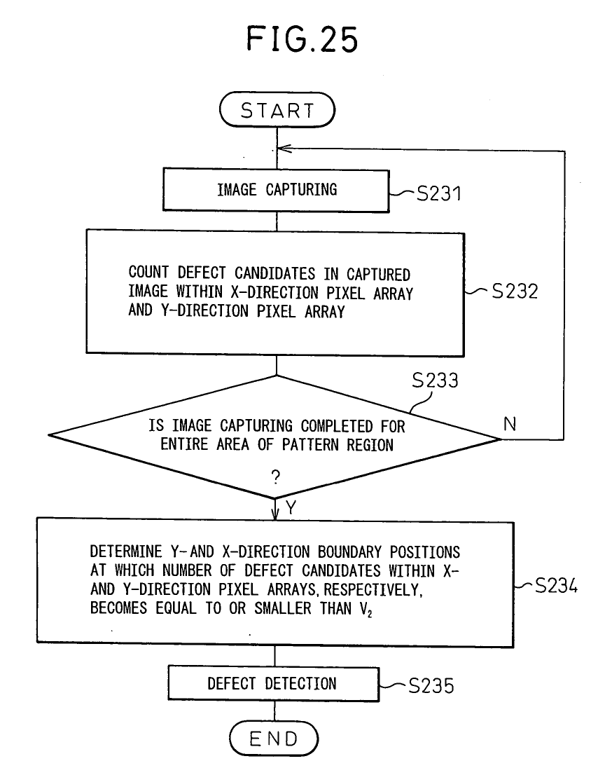

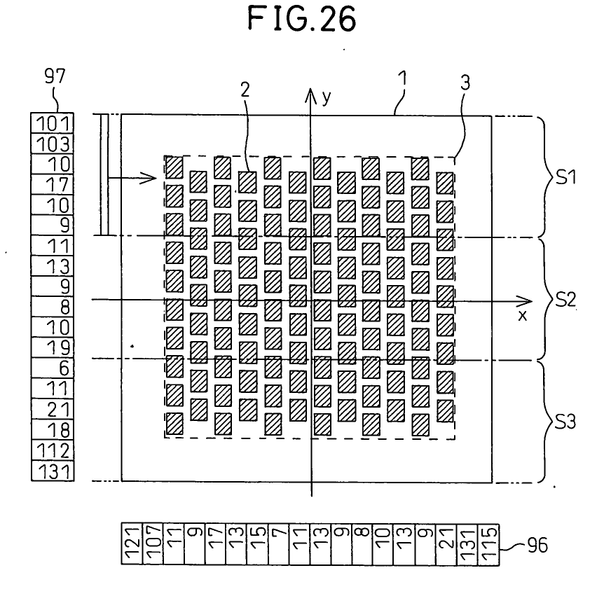

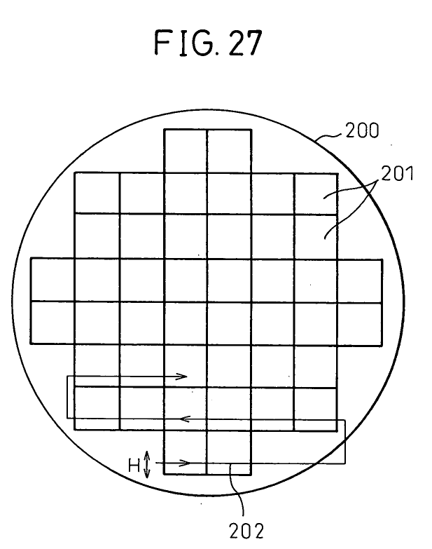

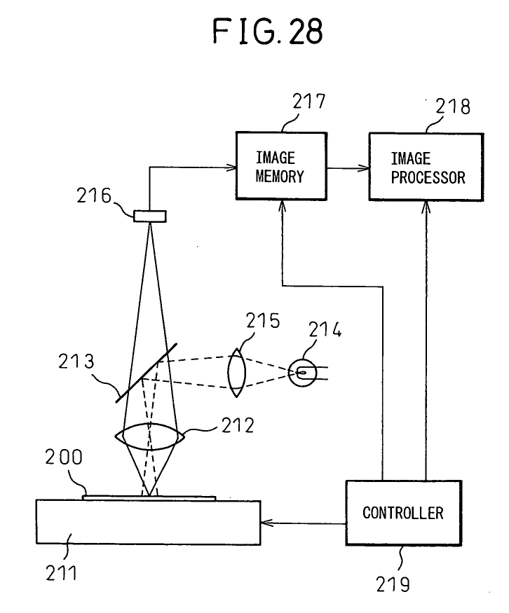

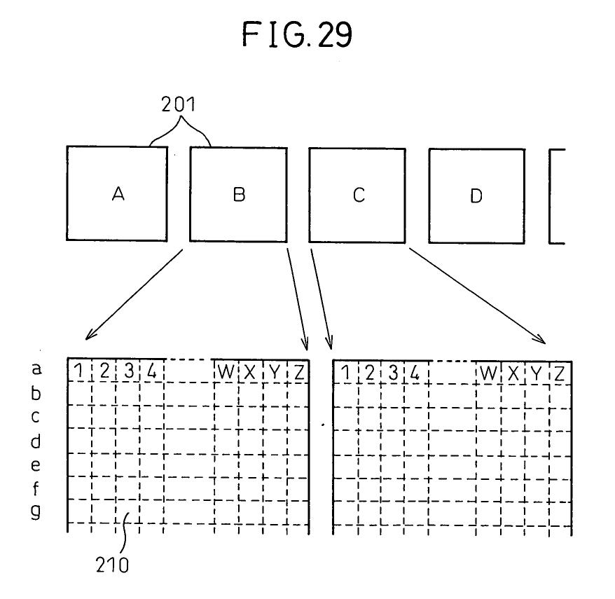

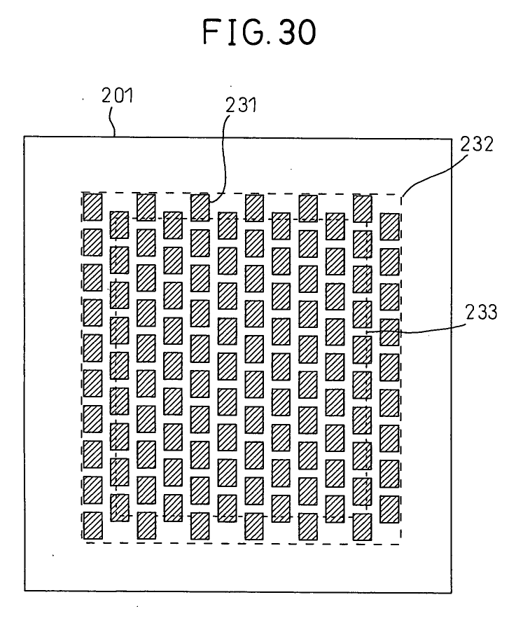

FIG. 25 is a flowchart of a pattern comparison inspection method according to the fourth embodiment of the present invention. First, in step S231, the imaging portion 20 captures an image of the pattern formed on the wafer 22. In this case, the imaging portion 20 captures the image, for example, by dividing the die 1 into three blocks S1 to S3, as shown in FIG. 26.

In step S232, the cell comparing portion 26 computes the difference value between the image signal (the value of each pixel) output from the A/D converter 23 and the image signal delayed by the delay memory 84, and detects the pixel as a defect candidate if the computed difference value is larger than the predetermined threshold value V1. Then, while the defect candidate map generating portion 85 is constructing the defect candidate map, the inspection range determining portion 88 counts the total number of defect candidates detected by the cell comparing portion 26 for each X-direction pixel array and each Y-direction pixel array in the captured image of the die 1, and stores the counts in X-direction one-dimensional array data 96 and Y-direction one-dimensional array data 97, respectively.

By performing the steps S231 to S232 across the entire cell region 1 for the pattern comparison inspection (S233), the total number of defect candidates contained in the captured image is counted for each X-direction pixel array and each Y-direction pixel array over the entire cell region 1, and the one-dimensional array data 96 and 97 are thus obtained. When creating the X-direction one-dimensional array data 96, the data is computed by summing the total numbers of defect candidates detected as the blocks S1 to S3 are scanned in sequence by the imaging portion 20.

Then, in step S234, the X-direction position and Y-direction position at which the number of defect candidates in the respective array data 96 and 97 becomes equal to or smaller than the predetermined threshold value V₂ are computed to determine the X-direction range and Y-direction range, respectively; then, in step S235, the cell comparing defect detecting portion 90 detects defects contained in the cell region within the thus determined inspection range in the cell comparing defect candidate map, and the die comparing defect detecting portion 89 detects defects contained in the outside-the-cell region which corresponds to the portion of the die comparing defect candidate map that lies outside the thus determined inspection range.

In the example of FIG. 25, the number of defect candidates is counted at the same time that the imaging portion 20 captures the image, but instead, the number of defect candidates may be counted for each X-direction pixel array and each Y-direction pixel array after capturing and storing all the images of the repeated pattern region; in that case, the counting of the number of defect candidates may be started from a position inside the boundary of the cell range precalculated from the CAD data, etc., and the X-direction position and Y-direction position at which the number of defect candidates in the respective pixel arrays exceeds the predetermined threshold value V₂ may be determined as defining the inspection range boundary.

While the preferred modes of the present invention have been described in detail above, it will be understood, by those skilled in the art, that various modifications and changes can be made by anyone skilled in the art, and that all of such modifications and changes that come within the range of the true spirit and purpose of the present invention fall within the scope of the present invention as defined by the appended claims.

### POTENTIAL FOR EXPLOITATION IN INDUSTRY

The present invention can be applied to appearance inspection in which a pattern such as a photomask pattern or a pattern formed on a semiconductor wafer of a semiconductor memory or the like is inspected by sequentially comparing one cell pattern with another cell pattern in the neighborhood thereof.

1. A pattern comparison inspection method which captures an image of an inspection target pattern having a repeated pattern region with repeated patterns formed in a repeated fashion at a prescribed repeat pitch, and which detects a defect in said inspection target pattern by comparing image signals taken from positions located a first integral multiple of said repeat pitch away from each other within an inspection region defined inside said repeated pattern region, said method comprising:
a reference position selecting step for selecting from among positions on said inspection target pattern a reference position which is judged whether it should be contained in said inspection region;
an image comparing step for comparing an image signal at said reference position with an image signal at a position located a second integral multiple of said repeat pitch away from said reference position and a prescribed distance inward of the boundary of a region that is known to be said repeated pattern region; and
an inspection region setting step for setting said inspection region by containing therein said reference position when a comparison result from said image comparing step shows a value not greater than a prescribed threshold value.

2. A pattern comparison inspection method which captures an image of an inspection target pattern having a repeated pattern region with repeated patterns formed in a repeated fashion at a prescribed repeat pitch, and which detects a defect in said inspection target pattern by comparing image signals taken from positions located a first integral multiple of said repeat pitch away from each other within an inspection region defined inside said repeated pattern region, said method comprising:
a reference position selecting step for selecting a reference position which is judged whether it should be contained in said inspection region, by incrementally shifting said reference position by a prescribed distance within said inspection target pattern;
an image comparing step for comparing an image signal at said reference position with an image signal at a position located a second integral multiple of said repeat pitch away from said reference position; and
an inspection region setting step for setting said reference position as the boundary of said inspection region when a comparison result from said image comparing step performed by incrementally shifting said reference position by said prescribed distance shows a change greater than a prescribed threshold value.

3. A pattern comparison inspection method which captures an image of an inspection target pattern having a repeated pattern region with repeated patterns formed in a repeated fashion at a prescribed repeat pitch, and which detects a defect in said inspection target pattern by comparing image signals taken from positions located a first integral multiple of said repeat pitch away from each other within an inspection region defined inside said repeated pattern region, said method comprising:
a reference position selecting step for selecting a reference position which is judged whether it should be contained in said inspection region, by incrementally shifting said reference position by a prescribed distance within said inspection target pattern;
an image comparing step for comparing an image signal at said reference position with an image signal at a position located a second integral multiple of said repeat pitch away from said reference position; and
an inspection region setting step for setting said reference position as the boundary of said inspection region when a comparison result from said image comparing step performed by incrementally shifting said reference position by said prescribed distance shows a maximum change.

4. A pattern comparison inspection method as claimed in any one of claims 1 to 3, wherein said image comparing step compares said image signal at said reference position with an image signal at a position located further inside said repeated pattern region than said reference position is.

5. A pattern comparison inspection method as claimed in any one of claims 1 to 3, wherein a position located a prescribed distance inward of the boundary of said repeated pattern region is selected as said reference position, and
said inspection region is set by repeatedly performing said image comparing step while incrementally moving said reference position outwardly toward the boundary of said repeated pattern region.

6. A pattern comparison inspection method as claimed in claim 2 or 3, further comprising a tentative region setting step for setting a tentative region a prescribed distance inward of the boundary of said repeated pattern region, and wherein
said image comparing step compares said image signal at said reference position with an image signal at a position located inside said tentative region.

7. A pattern comparison inspection method as claimed in any one of claims 1 to 3, further comprising a tentative region setting step for setting a tentative region a prescribed distance inward of the boundary of said repeated pattern region, and wherein
a position located inside said tentative region is selected as said reference position, and
said inspection region is set by repeatedly performing said image comparing step while incrementally shifting said reference position outwardly toward the boundary of said repeated pattern region.

8. A pattern comparison inspection method as claimed in any one of claims 1 to 3, wherein a position located a prescribed distance outward of the boundary of said repeated pattern region is selected as said reference position, and
said inspection region is set by repeatedly performing said image comparing step while incrementally shifting said reference position inwardly toward the boundary of said repeated pattern region.

9. A pattern comparison inspection apparatus which comprises an imaging portion which captures an image of an inspection target pattern having a repeated pattern region with repeated patterns formed in a repeated fashion at a prescribed repeat pitch, a storing portion which stores said captured image of said inspection target pattern, a pattern comparing portion which compares, on said stored image, image signals taken from positions located a first integral multiple of said repeat pitch away from each other within an inspection region defined inside said repeated pattern region, and a defect detecting portion which detects a defect in said inspection target pattern based on a result of said comparison, said apparatus comprising:
a reference position selecting portion which selects from among positions on said inspection target pattern a reference position which is judged whether it should be contained in said inspection region;
an image comparing portion which compares an image signal at said reference position with an image signal at a position located a second integral multiple of said repeat pitch away from said reference position and a prescribed distance inward of the boundary of a region that is known to be said repeated pattern region; and
an inspection region setting portion which sets said inspection region by containing therein said reference position when a comparison result from said image comparing portion shows a value not greater than a prescribed threshold value.

10. A pattern comparison inspection apparatus which comprises an imaging portion which captures an image of an inspection target pattern having a repeated pattern region with repeated patterns formed in a repeated fashion at a prescribed repeat pitch, a storing portion which stores said captured image of said inspection target pattern, a pattern comparing portion which compares, on said stored image, image signals taken from positions located a first integral multiple of said repeat pitch away from each other within an inspection region defined inside said repeated pattern region, and a defect detecting portion which detects a defect in said inspection target pattern based on a result of said comparison, said apparatus comprising:
a reference position selecting portion which selects a reference position which is judged whether it should be contained in said inspection region, by incrementally shifting said reference position by a prescribed distance within said inspection target pattern;
an image comparing portion which compares an image signal at said reference position with an image signal at a position located a second integral multiple of said repeat pitch away from said reference position; and
an inspection region setting portion which sets said reference position as the boundary of said inspection region when a comparison result, obtained from said image comparing portion as a result of incrementally shifting said reference position by said prescribed distance, shows a change greater than a prescribed threshold value.

11. A pattern comparison inspection apparatus which comprises an imaging portion which captures an image of an inspection target pattern having a repeated pattern region with repeated patterns formed in a repeated fashion at a prescribed repeat pitch, a storing portion which stores said captured image of said inspection target pattern, a pattern comparing portion which compares, on said stored image, image signals taken from positions located a first integral multiple of said repeat pitch away from each other within an inspection region defined inside said repeated pattern region, and a defect detecting portion which detects a defect in said inspection target pattern based on a result of said comparison, said apparatus comprising:
a reference position selecting portion which selects a reference position which is judged whether it should be contained in said inspection region, by incrementally shifting said reference position by a prescribed distance within said inspection target pattern;
an image comparing portion which compares an image signal at said reference position with an image signal at a position located a second integral multiple of said repeat pitch away from said reference position; and
an inspection region setting portion which sets said reference position as the boundary of said inspection region when a comparison result, obtained from said image comparing portion as a result of incrementally shifting said reference position by said prescribed distance, shows a maximum change.

12. A pattern comparison inspection apparatus as claimed in any one of claims 9 to 11, wherein said image comparing portion compares said image signal at said reference position with an image signal at a position located farther inside said repeated pattern region than said reference position is.

13. A pattern comparison inspection apparatus as claimed in any one of claims 9 to 11, wherein a position located a prescribed distance inward of the boundary of said repeated pattern region is selected as said reference position, and
said inspection region is set by repeatedly performing said comparison by said image comparing portion while incrementally moving said reference position outwardly toward the boundary of said repeated pattern region.

14. A pattern comparison inspection apparatus as claimed in claim 10 or 11, further comprising a tentative region setting portion which sets a tentative region a prescribed distance inward of the boundary of said repeated pattern region, and wherein
said image comparing portion compares said image signal at said reference position with an image signal at a position located inside said tentative region.

15. A pattern comparison inspection apparatus as claimed in any one of claims 9 to 11, further comprising a tentative region setting portion which sets a tentative region a prescribed distance inward of the boundary of said repeated pattern region, and wherein
a position located inside said tentative region is selected as said reference position, and
said inspection region is set by repeatedly performing said comparison by said image comparing portion while incrementally shifting said reference position outwardly toward the boundary of said repeated pattern region.

16. A pattern comparison inspection apparatus as claimed in any one of claims 9 to 11, wherein a position located a prescribed distance outward of the boundary of said repeated pattern region is selected as said reference position, and
said inspection region is set by repeatedly performing said comparison by said image comparing portion while incrementally shifting said reference position inwardly toward the boundary of said repeated pattern region.

17. (canceled)

18. (canceled)

19. (canceled)

20. (canceled)

21. (canceled)

22. (canceled)

23. (canceled)

24. (canceled)
